(19) United States
(12) Patent Application Publication
(10) Pub. No.: US 2026/0238486 A1
(43) Pub. Date: Aug. 13, 2026

(54) A BIOMETRIC HASH MATCHING METHOD AND SYSTEM, PARTICULARLY A FINGERPRINT HASH MATCHING METHOD AND SYSTEM

(71) Applicant: CSIR, Brummeria (ZA)

(72) Inventors: Graham David BARBOUR, Brummeria, Pretoria (ZA); Portia KHANYILE, Pretoria (ZA); Thato BOATENG, Pretoria (ZA); Edwin RAMPINE, Brummeria, Pretoria (ZA)

(73) Assignee: CSIR, Brummeria (ZA)

(21) Appl. No.: 19/471,183

(22) PCT Filed: Apr. 2, 2024
(86) PCT No.: PCT/IB2024/053189

§ 371 Date: Sep. 30, 2025

(30) Foreign Application Priority Data
Mar. 30, 2023 (NL) 2034473
Mar. 30, 2023 (NL) 2034475
Mar. 30, 2023 (NL) 2034476

(51) Int. Cl. H04L 9/32; G06V 40/12; H04L 9/06

(52) U.S. Cl. CPC H04L 9/3231; G06V 40/1353; G06V 40/1371; H04L 9/0643

(57) ABSTRACT

This disclosure relates to biometric hash matching methods and systems for one or more of identification, verification, or authentication applications, particularly, though not necessarily exclusively, for biometrics in the form of fingerprints. In the disclosure, a plurality of enrolled hashed templates is stored in a memory device in the form of a database communicatively coupled to at least one processor. Each enrolled hashed template comprises a hash, with a suitable hashing function, of an enrolled user password, a salt, and fingerprint data associated with a fingerprint of an enrolled user. Upon receipt of the same, a probed hashed template is compared with one or more enrolled hashed templates stored in the database to determine a match. The probed hashed template comprises a hash, with the suitable hashing function, of a probed user password, the salt, and fingerprint data associated with a fingerprint of the probed user.

### CROSS-REFERENCE TO RELATED APPLICATIONS

This application is a national stage application filed under 35 U.S.C. § 371 of PCT Application No. PCT/IB2024/053189, filed Apr. 2, 2024, which claims priority to Netherlands Patent Application No. 2034473, filed Mar. 30, 2023, Netherlands Patent Application No. 2034475, filed Mar. 30, 2023, and Netherlands Patent Application No. 2034476, filed Mar. 30, 2023, the entire contents of each of which is hereby incorporated by reference.

### FIELD OF INVENTION

THIS INVENTION relates to biometric hash matching methods and systems for one or more of identification, verification, or authentication applications, particularly, though not necessarily exclusively, for biometrics in the form of fingerprints.

### BACKGROUND OF DISCLOSURE

Many computerised security procedures and systems require biometric data from users to be captured and verified or authenticated before being permitted to perform certain restricted actions such as accessing restricted computer/s or computer system/s including memory devices thereon such bank accounts stored on bank servers, accessing designated areas, and the like. “Biometric” data may be understood to refer to distinctive human characteristics or traits that is able to be captured electronically in a manner that they may subsequently be used to identify individual people. For example, human features which may be electronically captured to provide biometric data comprise human fingerprints, palm prints, human iris or retina, voice, facial feature/s, and the like.

Users typically enroll themselves for subsequent identification, verification, and authentication by supplying biometric data. In the case of biometric data in the form of fingerprints, users enroll themselves by providing their fingerprints which are associated therewith. Mathematical representations of the fingerprints in the form of fingerprint minutia templates are extracted from received fingerprints provided by the users and are stored in a suitable storage media for subsequent matching for identification, verification, or authentication purposes.

While only a mathematical representation of a fingerprint, if an attacker were to obtain such a fingerprint minutia template, they have effectively obtained enough information to masquerade as the owner of this fingerprint. The attacker could simply reuse the template directly, or reverse engineer the template to generate a simulated fingerprint image that would produce the same or similar template when scanned.

It has even been shown that the original fingerprint can be reverse engineered accurately from a standard fingerprint minutia template, and techniques for reverse engineering templates will grow with time. The owner's fingerprint has effectively been stolen as a person cannot change their fingerprints.

To compound problems, it has recently been shown that biometric fingerprint matching systems, even those that return only a yes or no answer, can be queried by an attacker into revealing the fingerprints in the database.

One approach to address the aforementioned problems has been to use biometric data as inputs to a suitable secure hashing function which outputs hashes or hashed values of the input biometric data which are then stored and used in place of biometric data for purposes of one or more of identification, verification and authentication of users. For example, fingerprint minutia templates are hashed with a suitable hashing function to provide hashed templates which are stored in a suitable media and are used for one or more of identification, verification, and authentication. In this way, the risk associated with communicating and storing fingerprint minutia templates is mitigated as it is only hashed templates which are communicated and stored.

However, there are drawbacks with conventional systems which employ hashing methods in processing data in the manner described herein as they are not immune not immune to attack and often have relatively high error rates relative to the generally acceptable error rates for fingerprint matching.

One disclosure which the Applicant is aware of is described in US 2017/0085562 (“Schultz”). In the disclosure described in Schultz, a biometric identification system is disclosed which calculates rotationally and translationally invariant or independent features of minutia pairs which are then combined with a cryptographic salt to generate a hash which is used for biometric identification. The rotation and translation invariance are with respect to scanning of a fingerprint thereby to cater for rotational and translational differences which may arise in the scanning of a fingerprint. Shultz actively calculates these rotationally and translationally invariant or independent features by a) determining a central feature or a global fixed point on a minutia template; b) determining a position of each minutia in the minutia pairs relative to the central feature using techniques such as identifying a special structure or calculating a centre of mass. In addition to being computationally exhaustive, the Applicant has found that such techniques lead to decreased biometric matching accuracy, and inaccuracy increases in cases such as partial and damaged fingerprints. In particular, by adding an extra variant into the matching process, that is, calculating a global fixed point, adds an additional biometric inaccuracy (over and above that incurred from approximation by use of equivalence).

The present invention disclosed herein seeks at least to address and ameliorate the drawbacks described herein and at least to provide an alternate approach to biometric matching.

### SUMMARY OF DISCLOSURE

According to one aspect of the disclosure, there is provided a biometric feature hash matching method, wherein the method comprises:
storing a plurality of enrolled hashed templates in a database communicatively coupled to a server, wherein each enrolled hashed template comprises a hash of a user password associated with an enrolled user, a salt, and biometric data indicative of, or associated with, at least one biometric feature of the enrolled user with a suitable hash function; and
comparing, at the server, a probed hashed template, associated with a probed user, with the plurality of enrolled hashed templates stored in the database to determine a match, wherein the probed hashed template comprises a hash of a probed user password, the salt, and biometric data indicative of, or associated with, at least one biometric feature of the probed user.

According to another aspect of the disclosure, there is provided a fingerprint hash matching method, wherein the method comprises:
storing a plurality of enrolled hashed templates in a memory device communicatively coupled to at least one processor, wherein each enrolled hashed template comprises a hash, with a suitable hashing function, of an enrolled user password, a salt, and fingerprint data associated with a fingerprint of an enrolled user obtained from a fingerprint minutia template containing a plurality of minutiae associated with the fingerprint of the enrolled user, wherein the fingerprint data comprises a unique class identifier (UCI) associated with each n-tuple of a plurality of n-tuples of minutiae from the minutia template, wherein an n-tuple is of a fixed size and comprises at least a pair of minutia points, and wherein the UCI is determined from at least equivalence classes which partition the minutia template based on features of the at least one minutiae pair which are inherently rotationally and translationally invariant, and wherein each enrolled hashed template further comprises suitable remainder hashes associated with the features of each n-tuple which are rotationally and translationally invariant, wherein the remainder hashes are associated with remainders from associating the features determined to be rotationally and translationally invariant with the respective equivalence classes; and
comparing a probed hashed template with one or more enrolled hashed templates stored in the memory device to determine a match.

The biometric data may be representative, or indicative, of classes which partition at least pairs of biometric data points of a biometric data template comprising a plurality of biometric data points related to the at least one biometric feature of the enrolled or probed user.

In some example embodiments, the biometric data can be in the form of the biometric data template, data from the biometric data template, or other biometric data which may be used to identify the user.

In one example embodiment, the method can comprise receiving or generating, at the server, the probed hashed template from an endpoint computing device, remote from the server.

The method can comprise processing a biometric data template containing a plurality of biometric data points related to at least one biometric feature of the probed user by partitioning at least pairs of the biometric data points into a plurality of classes based on one or more attributes of the biometric data points which are rotationally and translationally invariant, wherein the biometric data is representative, or indicative, of the partitioning of at least pairs of the biometric data points.

The method can comprise:
receiving the probed user password;
obtaining a biometric data template containing a plurality of biometric data points related to at least one biometric feature of the probed user;
processing the biometric data template to obtain biometric data; and
hashing the received probed user password, the stored salt, and the biometric data with a suitable hash function to generate the probed hash template, for comparing.

In one example embodiment, the steps in the preceding paragraph can be at the remote endpoint computing device. The remote endpoint computing device can be a mobile computing device associated with the user operating under instruction of at least a suitable software application stored in a suitable memory device of the mobile computing device, wherein the memory device is coupled to a processor of the mobile computing device. The suitable software application can be configured to direct the processor of the mobile computing device to receive the probed user password, obtain the biometric data template, process the biometric data template, and hash as described above.

The method can comprise transmitting the probed hashed template to the server, via a suitable communications module of the mobile computing device. Transmission may be encrypted. Generating and transmitting the probed hashed template in this fashion conveniently increases the inherent security of the system by avoiding having to transmit sensitive personal data associated with the probed user from their mobile computing device which could be intercepted by hackers, or the like.

In other example embodiments, the suitable software application may be configured to direct the processor of the mobile computing device to receive the user password, and obtain the biometric data template, and transmit the same to the server for processing of the biometric data template and hashing.

The user password can be a numeric or alphanumeric string which is unique to a user. In some example embodiments, the user password can comprise a user identifier uniquely associated with the user. In other example embodiments, the user identifier may form part of the hash.

The salt can be an organisational salt associated with the organisation implementing the matching described herein. The salt may be stored on a suitable memory device of the mobile computing device associated with the user. The salt may be stored in the memory device together with the software application.

The hashing function may be a conventional cryptographically secure hashing function.

The method can comprise processing the biometric data template by partitioning at least pairs of the biometric data points into a plurality of classes based on one or more attributes of the biometric data points which are rotationally and translationally invariant, wherein the biometric data is indicative of, or associated with, partitioning of the biometric data points into the plurality of classes. The biometric data can thus comprise unique identifiers of the classes, or data indictive thereof.

The method can comprise:
receiving an image containing at least one biometric feature of the probed user; and
processing the received image to obtain the biometric data template containing a plurality of biometric data points related to the at least one biometric feature of the probed user.

In some example embodiments, the steps in the preceding paragraph may be performed by the mobile computing device. Instead, or in addition, the server is configured to receive the image captured by a suitable camera of the mobile computing device and process the same accordingly.

The biometric features can be selected from a group comprising fingerprints, facial features, retinal/iris features, voice features, DNA, or the like which serve to uniquely identify and/or distinguish one user from another. It will be appreciated that in the case of the biometric features being fingerprints, the biometric data template may be a fingerprint minutia template having a plurality of data points in the form of fingerprint minutia as is explained in greater detail herein.

According to another aspect of the disclosure, there is provided a biometric feature hash matching system, wherein the system comprises:
a database storing a plurality of enrolled hashed templates, wherein each enrolled hashed template comprises a hash of a user password associated with an enrolled user, a salt, and biometric data indicative of, or associated with, at least one biometric feature of the enrolled user with a suitable hash function; and
at least one processor configured to compare a probed hashed template, associated with a probed user, with the plurality of enrolled hashed templates stored in the database to determine a match, wherein the probed hashed template comprises a hash of a probed user password, the salt, and biometric data indicative of, or associated with, at least one biometric feature of the probed user.

The system can comprise an endpoint computing device in the form of a mobile computing device with the software application, as described above stored in the memory device of the mobile computing device. The at least one processor and the database may be provided by one or more servers.

The mobile computing device or the at least one processor may be configured to perform the method, or steps of the method, as described above.

The mobile computing device can comprise a suitable camera to capture images, and a communication module to facilitate communication of data between the mobile computing device and the one or more servers.

According to another aspect of the disclosure, there is provided a fingerprint hash matching method, wherein the method comprises:
storing a plurality of enrolled hashed templates in a database communicatively coupled to at least one processor, wherein each enrolled hashed template comprises a hash, with a suitable hashing function, of an enrolled user password, a salt, and fingerprint data associated with a fingerprint of an enrolled user; and
comparing a probed hashed template with one or more enrolled hashed templates stored in the database to determine a match, wherein the probed hashed template comprises a hash, with the suitable hashing function, of a probed user password, the salt, and fingerprint data associated with a fingerprint of the probed user.

The at least one processor and the database may be provided by one or more servers.

In one example embodiment, the method can comprise receiving, at the at least one processor, the probed hashed template from an endpoint computing device for comparing at the at least one processor. The endpoint computing device can be in the form of a mobile computing device. In this example embodiment, it will be appreciated that the method steps described herein leading up to generating the probed hashed template can be performed by the mobile computing device associated with the probed user in a manner described above. As alluded to above, the safety and security of this example embodiment is preferable as sensitive personal information is not transmitted.

Notwithstanding, in another example embodiment, the method can comprise generating, at the at least one processor, the probed hashed template for comparing at the at least one processor. In this way, the mobile computing device merely collects data and transmits the same to the server wherein the at least one processor generates the probed hashed template as described herein.

In yet a further example embodiment, the method can comprise performing one or more of steps to generate the probed hashed template at both the mobile computing device and the at least one server. In other words, the steps described herein to generate the probed hashed template may be shared and/or divided between the mobile computing device and the at least one server.

The fingerprint data may be associated with, or representative of, one or more attributes of the fingerprints which are rotationally and translationally invariant. In this way, the fingerprint data may thus be rotationally and translationally invariant.

The method can comprise:
processing a fingerprint minutia template containing a plurality of minutiae associated with the fingerprint of the probed user to obtain fingerprint data associated with, or representative of, one or more attributes of the fingerprint of the probed user which are rotationally and translationally invariant; and
hashing the received probed user password, the salt, and fingerprint data with a suitable hashing function to generate the probed hashed template.

In the preferred example embodiment, wherein the probed hashed template is generated by the mobile computing device, the method can comprise transmitting the probed hashed template to the at least one processor.

The hashing function can be a cryptographically secure hashing function. The salt can be an organisational salt which is common to an organisation implementing the matching described herein.

Processing the fingerprint minutia template to obtain the fingerprint data can comprise determining classes of at least pairs of minutiae in the fingerprint minutia template, wherein the classes partition the minutia template based on one or more attributes of the minutiae, or the pairs of minutiae, which are rotationally and translationally invariant, and wherein the fingerprint data is representative of the determined classes.

Differently defined, the processing the fingerprint minutia template can comprise allocating at least pairs of minutiae to classes based on attributes of the pairs of minutiae which are rotationally and translationally invariant. The attributes can be selected from a group comprising distance between the minutiae of the minutia pair, relative orientation angles of minutia of the minutia pair, and types of minutia of the minutia pair, which may be either ridges or bifurcations.

In one example embodiment, the method can comprise:
selecting n-tuples of minutiae from the minutia template, wherein each n-tuple is of a fixed size and comprises at least a pair of minutia points;
determining classes of the selected n-tuples from a plurality of classes which partition the minutia template based on attributes of the minutiae, or pair/s of minutiae, in the n-tuple which are rotationally and translationally invariant, and wherein the fingerprint data is representative of the determined classes of the n-tuples; and
hashing the received probed user password, the salt, and fingerprint data for each selected n-tuple, with a suitable hashing function, to generate a unit-digest hash; and
combining the unit-digest hashes to generate the probed hashed template or a hashed template which is used as a basis for the probed hashed template.

The method can comprise partitioning the minutia template into classes, wherein the classes partition the minutia template based on one or more attributes of the minutiae, or pairs of minutiae, which are rotationally and translationally invariant.

The method can comprise:
receiving a probed user password;
receiving an image captured by a camera of a mobile computing device, wherein the image contains at least one fingerprint of the probed user; and
processing the received image to extract the fingerprint minutia template containing a plurality of minutiae associated with the at least one fingerprint of the probed user contained in the image.

The method comprises processing the received image by:
generating a scan scale image of the fingerprint based on the received image; and
extracting the fingerprint minutia template from the scan scale image.

It will be appreciated that the scan scale image may be substantially similar in composition and scale as an image acquired by a conventional fingerprint scanner. These conventional images are typically black and white images which preserve data associated with attributes of the fingerprint, for example, the attributes described above which are rotationally and translationally invariant. In this way, the techniques disclosed herein may be employed with conventional black and white images acquired by conventional fingerprint scanners.

Each enrolled hashed template stored in the database may be uniquely associated with an enrolled user by way of one or more unique user identifier/s, wherein method may comprise:
receiving a user identifier associated with the probed user;
retrieving the enrolled hashed template associated with the received user identifier stored in the database; and
comparing the retrieved enrolled hashed template with the probed hashed template to authenticate the probed user.

In some example embodiments, the user identifier can be a username, or the like. The user identifier can be hashed along with the password, fingerprint data, and the salt.

As mentioned above and repeated herein for completeness, the method steps as described herein to generate the probed hashed template may be performed by the mobile computing device remote from the at least one processor, the at least one processor, or is shared between the mobile computing device and the at least one processor.

According to another aspect of the disclosure, there is provided a fingerprint hash matching system, wherein the system comprises:
a database storing a plurality of enrolled hashed templates, wherein each enrolled hashed template comprises a hash, with a suitable hashing function, of an enrolled user password, a salt, and fingerprint data associated with a fingerprint of an enrolled user; and
at least one processor communicatively coupled to the database and configured to compare a probed hashed template with one or more enrolled hashed templates stored in the database to determine a match, wherein the probed hashed template comprises a hash, with the suitable hashing function, of a probed user password, the salt, and fingerprint data associated with a fingerprint of the probed user.

The database and the at least one processor may be provided in one or more servers as described herein.

In one example embodiment, the at least one processor can be configured to receive the probed hashed template from an endpoint computing device, for example, a mobile computing device which is remote from the at least one processor.

In another example embodiment, the at least one processor can be configured to generate the probed hashed template.

The system can comprise a mobile computing device associated with a probed user, wherein the mobile computing device comprises a memory device storing a suitable software application associated with the system, wherein the memory device is communicatively coupled to a suitable processor of the mobile computing device, and wherein the processor of the mobile computing device may be configured under instruction of the suitable software application to:
process a fingerprint minutia template containing a plurality of minutiae associated with the at least one fingerprint of the probed user to obtain fingerprint data, which is associated with, or representative of, one or more attributes of the fingerprint which are rotationally and translationally invariant; and
hash the received probed user password, the salt, and fingerprint data with a suitable hashing function to generate the probed hashed template; and
transmit the probed hashed template to the at least one processor.

The processor of the mobile computing device can be configured, under instruction of the suitable software application, to process the fingerprint minutia template to obtain the fingerprint data by determining classes of at least pairs of minutiae in the minutia template, wherein the classes partition the minutia template based on one or more attributes of the minutiae, or the pairs of minutiae, which are rotationally and translationally invariant, and wherein the fingerprint data is representative of the determined classes.

The processor of the mobile computing device can be configured, under instruction of the suitable software application, to partition the minutia template into classes, wherein the classes partition the minutia template based on one or more attributes of the minutiae, or pairs of minutiae, which are rotationally and translationally invariant.

The processor of the mobile computing device can be configured, under instruction of the suitable software application, to:
receive a probed user password;
receive an image captured by a camera of a mobile computing device, wherein the image contains at least one fingerprint of the probed user; and
process the received image to extract the fingerprint minutia template containing a plurality of minutiae associated with the at least one fingerprint of the probed user contained in the image.

The processor of the mobile computing device can be configured to process, under instruction of the suitable software application, the received image by:
generating a scan scale image of the fingerprint based on the received image; and
extracting the fingerprint minutia template from the scan scale image.

As mentioned, the at least one processor can be provided at, at least one server, and wherein the at least one processor can be configured to:
process a fingerprint minutia template containing a plurality of minutiae associated with the at least one fingerprint of the probed user to obtain fingerprint data associated with the fingerprint of the probed user, wherein the fingerprint data is, associated with, or representative of, one or more attributes of the fingerprint of the probed user which are rotationally and translationally invariant; and
hash the received probed user password, the salt, and fingerprint data with a suitable hashing function to obtain the probed hashed template.

The at least one processor can be configured to process the fingerprint minutia template to obtain the fingerprint data by determining classes of at least pairs of minutiae in the minutia template, wherein the classes partition the minutia template based on one or more attributes of the minutiae, or the pairs of minutiae, which are rotationally and translationally invariant, and wherein the fingerprint data is representative of the determined classes.

The at least one processor can be configured to partition the minutia template into classes, wherein the classes partition the minutia template based on one or more attributes of the minutiae, or pairs of minutiae, which are rotationally and translationally invariant.

The at least one processor can be configured to:
receive a probed user password;
receive an image captured by a camera of a mobile computing device, wherein the image contains at least one fingerprint of the probed user; and
process the received image to extract the fingerprint minutia template containing a plurality of minutiae associated with the at least one fingerprint of the probed user contained in the image.

The at least one processor can be configured to process the received image by:
generating a scan scale image of the fingerprint based on the received image; and
extracting the fingerprint minutia template from the scan scale image.

The above steps described with reference to the server and the mobile computing device may be separated in other ways between the same, not described herein.

Each enrolled hashed template stored in the database is uniquely associated with an enrolled user by way of one or more unique user identifier/s, wherein at least one processor is configured to:
receive a user identifier associated with the probed user;
retrieve the enrolled hashed template associated with the received user identifier stored in the database; and
compare the retrieved enrolled hashed template associated with received user identifier with the probed hashed template to authenticate the probed user.

According to another aspect of the disclosure, there is provided a method of enrolling a user fingerprint in a database communicatively coupled to at least one processor, wherein the method comprises:
receiving or obtaining a hashed template associated with a user to be enrolled, wherein the hashed template comprises a hash, with a suitable hashing function, of a user password, a salt, and fingerprint data associated with a fingerprint of the user to be enrolled;
and
storing the received hashed template to be enrolled in the database as an enrolled hashed template.

The method can comprise receiving the hashed template from a mobile computing device associate with the user to be enrolled.

The method can comprise:
receiving one or more user identifier/s associated with the user to be enrolled; and
associating the stored hashed template with the one or more received user identifier/s in the database.

According to another aspect of the disclosure, there is provided a method of enrolling a user fingerprint in a database communicatively coupled to at least one processor, wherein the method comprises:
receiving a user password of a user to be enrolled;
receiving or obtaining fingerprint data associated with a fingerprint of the user to be enrolled, wherein the fingerprint data is associated with, or representative of, one or more attributes of the fingerprint which are rotationally and translationally invariant;
hashing the received probed user password, a salt, and fingerprint data with a suitable hashing function to obtain a hashed template to be enrolled in the database; and
transmitting the hashed template for storage as an enrolled hashed template in the database or storing the hashed template to be enrolled in the database as an enrolled hashed template.

The method can comprise processing a fingerprint minutia template containing a plurality of minutiae associated with the fingerprint of the user to be enrolled to obtain fingerprint data.

The method can comprise partitioning the minutia template into classes, wherein the classes partition the minutia template based on one or more attributes of the minutiae, or pairs of minutiae, which are rotationally and translationally invariant.

The method can comprise:
receiving an image captured by a camera of a mobile computing device, wherein the image contains at least one fingerprint of the user to be enrolled; and
processing the received image to extract the fingerprint minutia template containing a plurality of minutiae associated with the at least one fingerprint of the user to be enrolled contained in the image.

The method can comprise processing the received image by:
generating a scan scale image of the fingerprint based on the received image; and
extracting the fingerprint minutia template from the scan scale image.

The method can comprise receiving and processing a scan scale image of a fingerprint of the user to be enrolled, from a database of scan scale images, to extract the fingerprint minutia template from the scan scale image, wherein the scan scale images in the database were acquired by a suitable fingerprint scanner. In this way, the disclosure provided herein may retrospectively process scan scale images in older databases to generate hashed templates for use, for example, in a manner described herein for identification, verification, or authentication. It will be understood that this approach may find application with enrolling hashed fingerprint templates of users which already have scan scale images of their fingerprint obtained from conventional fingerprint scanners stored in existing databases, for example, government databases.

According to another aspect of the disclosure, there is provided a processor-implemented method of processing an image of a fingerprint, wherein the method comprises:
receiving an image containing at least one finger, having a fingerprint, therein, wherein the image is captured by a camera;
applying a skin-colour based segmentation mask to the image to obtain a background-removed image or first processed image, wherein the segmentation is based on skin colour, wherein the background-removed image or first processed image contains the at least one finger isolated from its background;
processing the background-removed image or first processed image to obtain an illumination-enhanced image or second processed image which is has enhanced illumination relative to the background-removed image;
processing the illumination-enhanced image or second processed image to obtain a contrast-enhanced image or third processed image which has enhanced contrast relative to the illumination-enhanced image or second processed image; and
re-scaling the contrast-enhanced image or third processed image to a predetermined resolution to obtain a scan scaled image, wherein the scan scaled image approximates a conventionally scanned fingerprint.

The method can comprise applying a skin colour/tone-based segmentation wherein experimentally determined thresholds are applied to different channels of the fingerprint image.

In this regard, if the background has at least orange, brown, yellow, and tan hues which correspond to experimentally determined threshold/s that would indicate that the background in the image resembles skin tone, the method can comprise:
separating the received image into a HSV (Hue Saturation Value) colour space;
isolating a bright channel associated with the separated image to obtain an isolated channel;
blurring the isolated channel to obtain a blurred channel;
equalising the blurred channel to obtain an equalised channel; and
applying a binary segmentation to the equalised channel to generate the segmentation mask to apply to the image.

On the other hand, if the background has at least orange, brown, yellow, and tan hues which does not correspond to experimentally determined threshold/s that would indicate that the background in the image resembles skin tone, the method can comprise:
separating the received image into a LAB (CIELAB) colour space;
isolating a luminance channel associated with the separated image to obtain an isolated channel;
applying a CLAHE (Contrast Limited Adaptive Histogram Equalization) equalisation to the isolated channel to obtain an equalised channel; and
applying a binary segmentation to the equalised channel generate the segmentation mask to apply to the image.

Processing the background-removed image can comprise:
applying a Butterworth filter to the background-removed image to obtain a Butterworth filtered image;
thereafter applying a Gaussian filter to the Butterworth filtered image to obtain a Gaussian filtered image which has been smoothed to reduce noise introduced by the Butterworth filter; and
applying a Tophat filter to the Gaussian filtered image to obtain the illumination-enhanced image.

The method can comprise applying a low-pass Butterworth filter to even out the illumination throughout the image, ensuring that the illumination is uniform. In other words, the method may comprise applying a lowpass Butterworth filter to the background-removed image in order to normalize the illumination of the image by suppressing areas that have higher illumination. The Tophat filter turns the image to grayscale and applies a disk-shaped structuring element to remove any remaining uneven illumination.

Processing the illumination-enhanced image can comprise:
applying a median filter to the illumination-enhanced image to reduce noise, for example, salt and pepper noise; and
sharpening the median filtered illumination-enhanced image to obtain the contrast-enhanced image.

The method can comprise determining fingerprint image quality by:
determining a quality score of the background-removed, the illumination-enhanced, contrast-enhanced image, wherein the image, or portions thereof;
comparing the determined quality with a predetermined quality threshold score; and
discarding the image, or portion/s thereof, which do not meet the predetermined quality threshold score.

The method can comprise:
determining a reliability score from the contrast-enhanced image;
determining an orientation certainty level (OCL) score;
determining a NIST (National Institute of Standards and Technology of the United States of America) fingerprint image quality score (NFIQ); and
combining determined reliability score, OCL score, and NFIQ score to obtain the quality score.

The predetermined quality threshold score may be determined experimentally.

The method can comprise re-scaling the contrast-enhanced image to an ISO (International Standards Organisation) compliant resolution, for example, 500 dpi.

The method can comprise pre-scaling the contrast-enhanced image to a predetermined size. This ensures that the operations to be applied always work consistently regardless of type of capture device. This pre-scaling always maintains the aspect ratio.

The method can comprise:
determining an orientation field associated with directionality of ridges in the processed image;
dividing the processed image into a plurality of segments of a predetermined size, wherein for each segment, the method comprises:
determining a dominant ridge flow in the segment using a corresponding segment in the determined orientation field;
re-orienting the segments such that ridges in the segment are aligned at 90 degrees;
discarding unreliable segments to obtain a processed image;
determining a number of ridges per segment and obtaining an average ridge count for the segment;
determining a re-scale factor, wherein the re-scale factor is determined by the determined average ridge count and a desired ridge count per segment, wherein the desired ridge count is obtained experimentally; and
re-sizing the processed image by applying the re-scale factor thereto to obtain the scan scaled image.

The segments may be blocks of a predetermined size.

According to another aspect of the disclosure, there is provided a processor-implemented method of hashing a fingerprint minutia template, wherein the method comprises:
receiving a fingerprint minutia template comprising a plurality of fingerprint minutia;
receiving a user password;
determining a plurality of positionally distinct n-tuples of minutiae of fixed size n from the received fingerprint minutia template, wherein each n-tuple comprises at least one minutia pair;
wherein for each n-tuple in the determined plurality of positionally distinct n-tuples, the method comprises:
   determining a unique class identifier (UCI) of the n-tuple, wherein the UCI is associated with one of a predetermined number of equivalence classes, based on attributes of the n-tuple, or minutiae of the n-tuple, which are rotationally and translationally invariant;
combining the determined UCI, the user password, and a salt into a combined dataset; and
hashing the combined dataset with a hash function to obtain a unit-digest.

The method can comprise collecting the collecting the unit-digests into a hash or hashed template. The terms “hash template” and “hashed template” may be used interchangeably herein. It will be appreciated that each distinct n-tuple selected from the template may be transformed into a unit-digest. Thus, the hashed template may be a finite list of unit-digests. This hashed template may be referred to herein as a base hasher.

The “processor-implemented” methods as described herein may be analogous to “computer-implemented” methods.

The method can comprise concatenating the UCI, the salt, and the password before hashing. This may be a binary string concatenation. To this end, the method may comprise passing the UCI and/or the salt with zeros to ensure a predetermined number of bits. the predetermined number of bits to pad the UCI and the salt may be different.

In a preferred example embodiment, the n-tuple comprises two minutiae and as such the n-tuple is preferably a minutia pair or 2-tuple, reference may be made to the minutiae pair when referencing the n-tuple for brevity unless otherwise stated.

It will be appreciated that a minutia m, is an object of properties p, o, and t, where m.p is a point called the position, m.o is an angle called the orientation, and m.t, is the type taking values amongst {0, 1}, where 0 is a bifurcation and 1 a ridge ending.

The set of all minutiae encountered in the “real-world” scenarios under consideration is denoted M, and called the minutiae space.

A minutiae template T is a finite list of minutiae. Fingerprints may be optionally scanned and extracted to a minutiae template. Note that in the standard ISO minutiae template standard, angles are represented in degrees, and this convention is used herein.

It will be appreciated by those skilled in the art that a pair of minutia or minutia pair or 2-tuple m̅ in described herein is a pair of minutia <m̅[0], m̅[1]> which is drawn from the same minutia template. In this regard, for a minutia pair m̅, wherein:

$$∠ ( m \text{?} ) ≐ ∠ ( m \text{?} [ 0 ] \cdot p + m \text{?} [ 1 ] \cdot p ) ,$$

$$d ( m \text{?} ) ≐ \vert m \text{?} [ 0 ] \cdot p + m \text{?} [ 1 ] \cdot p \vert ,$$

$${ro}_{1} ( m \text{?} ) ≐ m \text{?} [ 0 ] \cdot o + ∠ ( m \text{?} ) ,$$

$${ro}_{2} ( m \text{?} ) ≐ m \text{?} [ 1 ] \cdot o + ∠ ( m \text{?} ) .$$

$$\text{?} \text{indicates text missing or illegible when filed}$$

It will be noted that for points p and q, ∠(p̅, q̅)=arctan 2(q̅,y−p̅,y, q̅,x−p̅,x), wherein arctan 2 is the 2-argument arctangent.

In this regard, d(m̅) is referred to herein as the distance, and ro₁(m̅) and ro₂(m̅) are the first and second relative orientations. In this regard, a minutiae pair m̅ is positionally distinct iff d(m̅))>0. For a minutiae template T, M²(T) may be the set of all positionally distinct minutiae pairs drawn over T.

Letting a be a transformation, m a minutia and T a minutiae template. The transformation α(m) of a minutia m, is the minutia obtained by transforming the position and orientation of m by α, and with the same type. Then α(T) is defined as the template [α(m): mϵT].By a “standard translation”, is meant any finite sequence of 2-dimensional rotations and translations.

Letting a be a standard translation and m̅ an n-tuple in the form of a minutia pair. It will be appreciated that d, r₀₁, r₀₂ are invariant under standard transformations, for example, for a minutia pair m̅ and a standard transformation α:

$$d ( m \text{?} ) = d ( α ( m \text{?} ) ) ,$$

$${ro}_{1} ( m \text{?} ) = {ro}_{1} ( α ( m \text{?} ) ) ,$$

$${ro}_{2} ( m \text{?} ) = {ro}_{2} ( α ( m \text{?} ) ) .$$

$$\text{?} \text{indicates text missing or illegible when filed}$$

It will be noted that m̅ and n̅ are type-identical if m̅[0],t=n̅[0],t and m̅[1],r=n[1],t, denoted m̅=ₜ n̅ and with m̅≠ₜ n̅ in a conventional manner. The co-pair of m̅ is the minutia pair <m̅[1]. m̅[0]>, denoted as co(m̅).

$$d ( co ( m \text{?} ) ) = d ( m \text{?} ) ,$$

$$∠ ( co ( m \text{?} ) ) = ∠ ( m \text{?} ) + 180 \text{?}$$

$${ro}_{1} ( co ( m \text{?} ) ) = {ro}_{2} ( m \text{?} ) + 180 ,$$

$${ro}_{2} ( co ( m \text{?} ) ) = {ro}_{1} ( m \text{?} ) + 180 ,$$

$$\text{?} \text{indicates text missing or illegible when filed}$$

wherein the set of all minutia pairs encountered in real-world scenarios under consideration is denoted as M² and is called the minutia pair space.

A minutiae tuple or n-tuple m̅=m₁, . . . , mₙ> may be positionally distinct if, for i≠j, the minutiae pair <mᵢ, mⱼ> is positionally distinct. For a minutiae template T, let Mⁿ(T) denote the set of all positionally distinct minutiae tuples drawn over T. The set of all minutiae n-tuples encountered in the “real-world” scenarios under consideration is denoted Mⁿ, and called the minutiae n-tuple space.

It will be understood by those skilled in the art that the symbol/characters/nomenclature m̅ may refer to a minutia n-tuple, m̅ may refer to a minutia pair, and m may refer to a minutia. The same is true, depending on the context, for other symbols/characters/nomenclature used herein.

The hash function may typically be a cryptographically secure hash function H, such as a SHA256 function, which takes an input message, data object, byte-array, binary string, or dataset, as an argument and produces a suitable digest. The hash function H may take any finite number of objects of any type as argument. In this regard, the method can comprise naturally and/or deterministically converting these objects into byte-arrays and concatenating the same into a single byte-array. Digests on the other hand are n-bit strings or

$$\frac{n}{8} -$$

length byte-arrays, wherein n is a fixed constant determined by H, called the dimension and denoted as H.dim.

The hash function should be pre-image resistant, i.e., given a digest it is (computationally) infeasible to find a message with that digest, second pre-image resistant, i.e., given a message it is infeasible to find another message with the same digest, and collision resistant, i.e., it is infeasible to find two different messages with the same digest.

In this regard, the hash function H should be correlation resistant. This is key to the security of the present disclosure. In this regard, this may be defined as follows: for every n>0 and f: [symbol] ⁿ→{0, 1} that is non-constant over [symbol] ⁿ, wherein M is the message space, and for all digests h₁, . . . , hₖ, wherein n≤h, and hᵢ=H(m₁), for some secret messages m₁, . . . , mₖ, it should be infeasible to determine the value of f((m₁, . . . , mₙ)) for any i₁, . . . , iₙ∈[1, . . . , k]; whereby Mⁿ is the set of all n-tuples over M.

In the present disclosure, the received minutia template as a data set may be transformed into a plurality of vectors of equivalence classes of different types, which is transformed into a plurality of numbers each of which is referred to as the UCI. It is these UCI's which are then hashed in the manner described herein.

An indexed partition P of a universe X≠ [symbol] of integral resolution r>1, is determined by any function p.idx from X onto an index set [0, 1 . . . , r−1]. The universe is denoted as P.uni, the resolution is denoted P.res and the index set is denoted P.indices.

Example 1: In an indexed partition P the real interval [0, 100) of resolution 10 is given by [symbol] .idx(x)≐md₀(x) mod 10.

For, i∈ [symbol] .indices, P[i] denotes the pre-image [symbol] .idx⁻³([i]), i.e., [symbol] [i]≐{x∈X: [symbol] .idx(x)−i}. called the (equivalence) class determined by index i. Hence, x∈[ [symbol] .idx(x)]. The array-like notation is purposefully provided.

An indexed partition may be defined simply by listing its classes in index order. The UCIs may thus be ordered indices corresponding to the classes. Hence, P is the indexed partition defined by P[0], . . . , P[P.res−1].

Example 2: In the previous example, P[i]=[10i, 10(i+1)), hence the classes are, in indexed order, [0, 10), [10, 20), . . . , [90, 100).

It will be noted that x∈ [symbol] .uni, [symbol] (m)≐ [symbol] [ [symbol] .idx(x)], i.e., P(a) is the unique class containing x, i.e., x∈ [symbol] (x). Functional notation is used here and thus distinction may be made between [symbol] .idx(⋅), [symbol] [⋅] and [symbol] (⋅).

Example 3: in the previous example, [symbol] (73.22)=[70, 80).

It will be appreciated that the present disclosure may be based on a Bozorth3 fingerprint matching system. For each minutia pair m̅ from T and each minutia pair n̅ from U, (by convention both positionally distinct) define a Boolean function Mₓ(m̅, n̅), defined by Mₙ(m̅, n̅)=true iff

$$\vert d ( m \text{?} ) - d ( n \text{?} ) \vert < δ ,$$

$$\vert {ro}_{1} ( m \text{?} ) - {ro}_{1} ( n \text{?} ) \vert < ϵ ,$$

$$\vert {ro}_{2} ( m \text{?} ) - {ro}_{2} ( n \text{?} ) \vert < ϵ ,$$

$$m \text{?} \text{?} n \text{?} .$$

$$\text{?} \text{indicates text missing or illegible when filed}$$

We call M_{B} the Bozorth3 match function. Note, Mₛ(m̅, n̅) iff m̅=ₜn̅ and there exists a standard transformation α such that α(m̅[1]) is close to n̅(1) and α(m̅[2]) is close to n̅[2], close in position and orientation, within tolerances determined by δ and ϵ.

Comparing templates T and U by counting matches may be effective but yields a poor EER (equal error rate), of around 0.33 by experiments. Such a high EER is obtained because while each matching pair must have a matching transformation, different matching pairs may have different transformations.

T and U should thus only be matched if there exists a (single) standard transformation α, such that many of the minutiae of U lie close to (and match type) those of α(T).

It has been observed that longer distances tend to vary more, while relative orientations tend to vary less the longer the distance. In this regard, the present invention as disclosed herein seeks to exploit this observation.

With d be the largest distance between two minutiae, determined experimentally, the method may comprise partitioning a real interval [0, d+1) into M contiguous subintervals l[0]−[0, l₀), l[1]−[l₀, l₁), . . . l[M−1]−[l_{M-1}, d+1). For let d∈[0, d+1) I(d) denote the unique index i with d∈l[i]. A M-length array of distance tolerances multipliers m_{d} and an M-length array of relative orientation tolerances multipliers mₒ, all of which are arrays of positive real numbers are provided, wherein a function Mₛ′(m̅, n̅)=true iff, letting i=l(avg(d(m̅), d(n̅)), is defined and

$$\vert d ( m \text{?} ) - d ( n \text{?} ) \vert < {m}_{d} [ i ] \times δ ,$$

$$\vert {ro}_{1} ( m \text{?} ) - {ro}_{1} ( n \text{?} ) \vert < {m}_{o} [ i ] \times ϵ$$

$$\vert {ro}_{2} ( m \text{?} ) - {ro}_{2} ( n \text{?} ) \vert < {m}_{o} [ i ] \times ϵ$$

$$m \text{?} \text{?} n \text{?} .$$

$$\text{?} \text{indicates text missing or illegible when filed}$$

In terms of the aforementioned observation 1=m_{d}[0]≤m_{d}[1]≤ . . . m_{d}[M−1], mₒ[0]≥mₒ[1]≥ . . . mₒ[M−1]−1.

Ideally the matching described above may be on a cycle basis. In this regard, for a cycle of length j, is meant distinct minutiae m₁, . . . , mⱼ from a minutia template T and distinct minutiae n₁, . . . , nⱼ from U such that Mₒ((mᵢ, mᵢ₊₁), (nᵢ, nᵢ₊₁)) for i=1, . . . , j−1 and Mₒ((mⱼ, m₂), (nⱼ, n₁))

It will be noted that a cycle of length j ensures that the same standard transformation maps j minutiae of T “close” to j minutia of U.

The number of cycles of length greater than 2 is determined using standard graph theoretic techniques, and a matching score determined from the number of cycles and the length of these cycles. The higher the matching score, the better the original fingerprints match.

However, finding cycles is relatively slow. In this regard, it will be noted that for any two minutiae pairs in and n̅ potential values for the translation are given by:

$$tr \text{?} ( m \text{?} , n \text{?} ) ≐ n \text{?} [ 1 ] \cdot p - m \text{?} [ 1 ] \cdot p$$

$$tr \text{?} ( m \text{?} , n \text{?} ) ≐ n \text{?} [ 2 ] \cdot p - m \text{?} [ 2 ] \cdot p$$

$$\text{?} \text{indicates text missing or illegible when filed}$$

and three potential values for the rotation are given by:

$${rot}_{1} ( m \text{?} , n \text{?} ) ≐ n \text{?} [ 1 ] \cdot o - m [ 1 ] \cdot o \text{?}$$

$${rot}_{2} ( m \text{?} , n \text{?} ) ≐ n \text{?} [ 2 ] \cdot o - m [ 2 ] \cdot o \text{?}$$

$${rot}_{1} ( m \text{?} , n \text{?} ) ≐ ∠ ( n ) - ∠ ( m ) \text{?}$$

$$\text{?} \text{indicates text missing or illegible when filed}$$

wherein ∠(n̅) is defined above.

It will be noted that assuming that Mₙ(m̅, n̅), then trl₁(m̅, n̅)≈trl₂(m̅, n̅) and rot₁(m̅, n̅)≈rot₂(m̅, n̅)≈rotₗ(m̅, n̅).

For each minutiae pair m̅ from T, and each minutiae pair n̅ from U, define M(m̅, n̅) iff Mₛ(m̅, n̅)
trl₁(m̅, n̅)≈trl₂(m̅, n̅)
rot₁(m̅, n̅)=rot₂(m̅, n̅)≈rotₗ(m̅, n̅).

In this regard, if M(m̅, n̅), t(m̅, n̅) may be defined as some function of trl₁(m̅, n̅) and trl₂(m̅, n̅), t(m̅, n̅) may be defined as some function of rot₁(m̅, n̅), rot₂(m̅, n̅), and rotₗ(m̅, n̅).

Some clustering technique may be used to divide the matching pairs (m̅, n̅) (i.e., distinct pair m̅ is drawn from T, distinct pair n̅ is drawn from U, and Mₒ(m̅, n̅)=true) with M(m̅, n̅)=true, into clusters with respects to translation t(m̅, n̅) and rotation r(m̅, n̅).

A matching score may be derived from the number of members of the cluster with the most members, together with information on the size of T and U.

In any event, the unit-digest and/or the hashed template generated in a manner described above may serve to match one or more stored enrolled hashed templates in a database for purposes of identification, verification, and/or authentication, in use. Instead, or in addition, unit-digest or the hashed template may be used as a basis for further hashed templates which may be derived from the generated unit-digest and/or hashed template.

From the foregoing, it will be appreciated that determining the UCI for each n-tuple is based on equivalence classes associated with attributes/features of the n-tuple selected from a group comprising type/s of each minutia of the n-tuple, distance/s between each minutia of the n-tuple, and relative orientation/s of minutia of the n-tuple.

For each n-tuple, the method can comprise:
determining a remainder associated with each determined feature which is rotationally and translationally invariant, wherein the remainder is a difference between the determined feature relative to, for example, modulo, the equivalence class associated with the respective determined feature; and
generating a suitable remainder hash from at least the determined remainder.

The remainder hash may be compared to other analogous valid hashes. Thus, the remainder hash may be used for matching purposes.

The method can comprise combining at least the unit digests and at least the suitable remainder hashes into a suitable template which may be used for subsequent matching with other similar templates.

The method for generating the suitable remainder hash may comprise mathematically shifting the determined remainders by a value associated with at least a hash of an identifier of an equivalent class, a salt, and the user password as described in more detail herein.

It will be noted that the use of remainders in the manner described herein, in detail, enables the invention disclosed herein to achieve a matching accuracy of close to standard biometric matching, with only the need for features built from two minutia. For example, for a typical minutiae template with 50 minutiae, the present disclosure requires only 50*49=2450 hashes in each hashed template. This much less than some prior art systems, for example, the features that are used in Schultz (FIG. 6 and FIG. 7) are determined by four minutiae. For a typical minutiae template with 50 minutiae there would be 50×49×48×47=5 527 200 hashes in each hashed template. This is huge to transport and store, and slow to match. With the present disclosure, the method comprises comparing a probed hashed template with an enrolled hashed template and when a probed and enrolled class match, their remainders may be compared (by subtraction) to provide additional accuracy as described in detail herein.

The method can comprise:
providing a distance partition having a plurality of distance sub-intervals, wherein each sub-interval is associated with a unique distance identifier (UDI);
providing an angle partition having a plurality of angle sub-intervals, wherein each angle sub-interval is associated with a unique angle identifier (UAI); and
wherein determining the UCI of each n-tuple is based on at least one of type/s of minutia in the n-tuple, a UDI of the at least one minutia pair in the n-tuple, and UAIs of the relative orientations of the at least one minutia pair in the n-tuple.

The method can comprise:
providing a map from UDIs to a plurality of angle partitions, wherein each angle partition has a plurality of angle sub-intervals, and wherein each angle sub-interval is associated with the unique angle identifier (UAI); and
wherein determining the UCI is based on at least one of the types of minutia in the n-tuple, UDI of the at least one minutia pair, and UAI of relative orientations of the at least one minutia pair in the angle partition determined by the UDI of the at least one minutia pair in the map.

Determining the UCI for each n-tuple of the plurality of positionally distinct n-tuples can comprise:
determining a distance between minutiae of the at least one minutia pair;
determining a UDI of the at least one minutia pair, wherein the UDI is an identifier of the sub-interval of the distance partition containing the determined distance;
determining a first relative orientation angle of the at least one minutiae pair;
determining a second relative orientation angle of the at least one minutiae pair;
determining a first UAI of the at least one minutia pair, wherein the first UAI is an identifier of the sub-interval of the angle partition determined by the determined UDI and the map, containing the determined first relative orientation angle of the minutiae of the at least one minutiae pair; and
determining a second UAI of the at least one minutia pair, wherein the second UAI is an identifier of the sub-interval of the angle partition determined by the determined UDI and the map, containing the determined second relative orientation angle of the minutiae of the at least one minutiae pair;
determining a first type of identifying data associated with one minutia of the at least one minutia pair, from at least two different identifying data types; and
determining a second type of identifying data associated with another minutia of the at least one minutia pair, from the at least two different identifying data types;
wherein determining the UCI is based on one or more of the determined UDI, the first and second UAI, the first type of identifying data, and the second type of identifying data.

For n-tuples with a plurality of minutiae, the method comprises performing the method for each consecutive distinct minutia pair in the n-tuple. For example, for a 5-tuple, i.e., n=5, the method may comprise performing the method for minutia pairs consisting of minutia 1 to 2, 2 to 3, 3 to 4, and 4 to 5, i.e. for a number of minutia pairs determined by n−1.

For each n-tuple, the method can comprise:
determining a distance remainder hash;
determining a first relative orientation remainder hash;
determining a second relative orientation remainder hash; and
generating a unit-hash comprising the unit-digest, the distance remainder hash of the at least one minutia pair, the first relative orientation remainder hash of the at least one minutia pair, and the second relative orientation remainder hash of the at least minutia pair.

The method may comprise determining a distance remainder hash, for each n-tuple, by:
determining a distance remainder associated with the at least one minutia pair;
combining the determined UDI, the user password, and a distance remainder salt into a combined distance remainder dataset;
hashing the distance remainder dataset with a hash function to obtain a distance hash;
applying a hash-transformation to the distance hash, wherein the hash-transformation maps the distance hash to a real number; and
adding the determined distance remainder to the hash-transformation of the distance hash, and rounding the resultant sum to a first predetermined number of decimal places to yield the distance remainder hash.

The method can comprise determining a first relative orientation remainder hash, for each n-tuple, by:
determining a first relative orientation remainder associated with the at least one minutia pair;
combining the determined UDI, the user password, and a first relative orientation remainder salt into a combined first relative orientation remainder dataset;
hashing the first relative orientation remainder dataset with a hash function to obtain a first relative orientation hash;
applying a hash-transformation to the first relative orientation hash wherein the hash-transformation maps the first relative orientation hash to a real number; and
adding the determined first relative orientation remainder to the hash-transformation of the first relative orientation hash and rounding the resultant sum to a second predetermined number of decimal places to yield the first relative orientation remainder unit hash.

The method can further comprise determining a second relative orientation remainder hash, for each n-tuple, by:
determining a second relative orientation remainder associated with the at least one minutia pair;
combining the determined UDI, the user password, and a second relative orientation remainder salt into a combined second relative orientation remainder dataset;
hashing the second relative orientation remainder dataset with a hash function to obtain a second relative orientation hash;
applying a hash-transformation to the second relative orientation hash, wherein the hash-transformation maps a range of the second relative orientation hash to a real number; and
adding the determined second relative orientation remainder to the hash-transformation of the second relative orientation hash, and rounding the resultant sum to the second predetermined number of decimal places to yield a second relative orientation remainder hash.

It will be appreciated that in example embodiments wherein n≥2, the generated unit hash may typically comprise the unit-digest, and distance remainder hashes, first relative orientation remainder hashes, and second relative orientation remainder hashes for multiple minutia pairs of the n-tuple.

The method can comprise:
determining the distance remainder by determining a difference between the determined distance of the at least one minutia pair and a lower bound of a sub-interval of the distance partition containing the determined distance;
determining the first relative orientation angle remainder by determining a difference between the first relative orientation angle of the at least one minutia pair and a lower bound of the sub-interval of the angle partition comprising the first relative orientation angle;
determining the second relative orientation angle remainder by determining a difference between the second relative orientation angle of the at least one minutia pair and a lower bound of the sub-interval of the angle partition comprising the second relative orientation angle; and
generating a sharpened unit-hash comprising the unit-digest, the distance remainder hash, the first relative orientation remainder hash, and the second relative orientation remainder hash.

The method can comprise collecting the generated sharpened unit-hashes into a sharpened hashed template.

The method may comprise, for each n-tuple, determining the distance remainder by:
providing a compactification factor based on the determined UDI;
determining a compactification value by determining a sum of the determined distance between the minutiae of the at least one minutia pair, and a product of the determined compactification factor and a difference between a midpoint of the sub-interval of the distance partition containing the determined distance and the determined distance; and
determining the distance remainder by determining a difference between the determined compactification value and the lower bound of the sub-interval of the distance partition containing the compactification value.

The method can comprise, for each n-tuple, determining the first relative orientation angle remainder by:
providing a first relative orientation compactification factor based on the determined first UAI;
determining a first relative orientation compactification value by determining a sum of the determined first relative orientation value, and a product of the determined first relative orientation compactification value and a difference between a midpoint of the sub-interval of the angle partition containing the determined first relative orientation angle and the determined first relative orientation value; and
determining the first relative orientation angle remainder by determining a difference between the determined first relative orientation compactification value and the lower bound of the sub-interval of the angle partition containing the first relative orientation compactification value.

The method may further comprise, for each n-tuple, determining the second relative orientation angle remainder by:
providing a second relative orientation compactification factor based on the determined second UAI;
determining a second relative orientation compactification value by determining a sum of the determined second relative orientation value, and a product of the determined second relative orientation compactification value and a difference between a midpoint of the sub-interval of the angle partition containing the determined second relative orientation angle and the determined second relative orientation value; and
determining the second relative orientation angle remainder by determining a difference between the determined second relative orientation compactification value and the lower bound of the sub-interval of the angle partition containing the second relative orientation compactification value;
The method can comprise generating a compact unit-hash comprising the unit-digest, the distance remainder hash, the first relative orientation remainder hash, and the second relative orientation remainder hash.

The method can comprise collecting the generated compact unit-hashes into a compact hashed template.

For each n-tuple, the method can comprise:
providing a label for each minutia of the minutia template; and
combining the unit-hash with the n-tuple of labels for each minutia of the minutia n-tuple.

The method can comprise:
determining a translation property to be added to each unit-hash, wherein the translation property is a point having an x component and a y component, by:
   providing a translation determinant function;
   deterministically mapping the n-tuple to an absolute point using the translation determinant function provided, wherein the absolute point has an absolute x component and an absolute y component;
   combining the UCI, the user password, and an x component organisational salt into a combined x component mapped dataset;
   hashing the x component mapped dataset with a hash function to obtain an x component mapped hash;
   applying a hash transformation to the x component mapped hash to obtain an x transformation;
   adding the absolute x component to the x transformation, and rounding the resultant sum to a first predetermined number of decimal places to yield the x component of the translation property;
   combining the UCI, the user password, and a y component organisational salt into a combined y component mapped dataset;
   hashing the y component mapped dataset with a hash function to obtain ay component mapped hash;
   applying a hash transformation to the y component mapped hash to obtain a y transformation; and
   adding the absolute y component to the y transformation, and rounding the resultant sum to the first predetermined number of decimal places to yield the y component of the translation property;
determining a rotation property to be added to each unit-hash, by:
   providing a rotation determinant function;
   deterministically mapping the n-tuple to an absolute angle with the provided rotation determinant function;
   combining the UCI, the user password, and a third global salt into a combined angle mapped dataset;
   hashing the angle mapped dataset with a hash function to obtain an angle mapped digest;
   applying a hash transformation to the angle mapped digest;
   adding the absolute angle to the hash transformation of the angle mapped digest; and
   converting the resultant sum to a form from 0° to 360° and rounding the converted resultant sum to a first predetermined number of decimal places to yield the rotation property to be added to the unit-hash; and
combining the unit-hash, the translation property, and the rotation property into an absolute unit-hash.

The method can comprise collecting the absolute unit-hashes into an absolute unit-hashed template.

The method can comprise receiving user specific data; and combining the user specific data with the received password prior to hashing. The user specific data may be any data specifically associated with the user and may comprise a user identifier, or any other user specific data which may be used for the purposes described herein, for example, a user's first or last name, their identity/social security number.

According to another aspect of the disclosure, there is provided a method of matching hashed templates, wherein the method comprises:
receiving a hashed template generated in a manner described above;
comparing the received hashed template to one or more hashed templates stored in a database; and
determining a match based on a degree of unit-digests of the received hashed template in common with the one or more hashed templates stored in the database.

Differently defined, from the foregoing, there is provided a method for hashing a fingerprint minutiae data T, i.e., data from any minutia template, such as obtained from a fingerprint scanner, a user password pw, which can be any string/byte-array, ideally concatenated with fixed user identifying information in order to prevent a common password attack, and a fixed organization specific salt $y, referred to as the root salt, where salts are any string/byte-array into a set H called the hashed template, which can be transmitted, stored and later used, wherein the method comprises:
(A) determining a set of distinct minutiae pairs from the template, possibly restricted by distance, referred to as the elected pairs;
(B) for each minutiae pair m̅ in the set:
   (i) determine the index i of the equivalence class containing m̅ in an indexed partition of all possible minutiae pairs, where membership is determined purely by
      the type of the first minutia in the pair, i.e., bifurcation or ridge-ending,
      the type of the second minutia in the pair,
      the distance d(m̅) between the two minutiae,
      the first relative orientation ro₁(m̅), i.e., the relative orientation of the first minutiae in the pair,
      the second relative orientation ro₂(m̅), i.e., the relative orientation of the second minutiae in the pair,
   noting that such an index must be both translation and rotation invariant;
   (ii) combining each index, with the user password pw and the organizational salt Sr, and converting the result to a byte-array/binary-string;
   (iii) hashing each byte-array/binary-string with a cryptographically secure hash function, such as SHA256, obtaining the unit-hash, noting that the unit-hash is both translation and rotation invariant;
(C) collecting all the unit-hashes in a set, which is the hashed template, with optional co-pair reduction.

Most generally, the hashed template may be determined by the cryptographic hash function H, a dimension n≥2, an integral index-bound 0<b, and an index-function id(⋅) from Mⁿ into the integral [0, b), such that for any standard transformation α and positionally distinct minutiae tuple m̅∈ [symbol] hu 5, id(m̅)−id(α(m̅)).

As mentioned above, the index i referred to herein is typically the UCI defined herein. It will be appreciated to those skilled in the art that indexing a finite set A, means a bijection from A onto [0, 1, . . . [A]−1].

The method can comprise using the hashed template, or a hashed template based on the hashed template above, for one or more of identification, verification, and authorisation of the user associated with the fingerprint minutia template.

The index i or UCI of a minutia pair m̅ in the selected set described above may be determined as follows:
(a) determining a distance index i_{d} which is defined as the index of the subinterval containing the distance d(m̅) in an indexed partition [symbol] , called the distance partition, of the interval [0, d+1) into contiguous subintervals, where d is the maximum possible distances between minutiae;
(b) determining the first relative orientation index iᵣₒ₁ which is defined as the index of the sub-interval containing the first relative orientation ro₁(m̅), in an indexed angle partition [symbol] [i_{d}], where each [symbol] [i_{d}] a partition of angles into contiguous subintervals, calling [symbol] the relative orientation partitions;
(c) determining the second relative orientation index iᵣₒ₂ which is defined as the index of the subinterval containing the second relative orientation ro₂(m̅)) in the angle partition [symbol] [i_{d}];
(d) determining the first type index iₜ₁ which his defined to 0 if the first minutiae of the pair is a bifurcation, and 1 otherwise;
(e) determining the second type index iₜ₂ which is defined to 0 if the second minutiae of the pair is a bifurcation, and 1 otherwise;
(f) determining the index i which is defined as:

$$i ≐ 4 {N}^{2} {i}_{d} + 4 Ni \text{?} - 4 {i}_{{ro}_{2}} + 2 {i}_{{t}_{1}} + {i}_{{t}_{2}} ,$$

$$\text{?} \text{indicates text missing or illegible when filed}$$

wherein N is the maximum number of sub-intervals of any [symbol] [i_{d}].

Example 4: Assume that the maximal real-world distance between two minutiae is just below 500. Define an indexed partition D by [0, 50), [50, 100), . . . , [400, 450), [450, 500), called the distance partition, and an indexed angle partition O defined by [0, 360), [36, 72), . . . , [324, 360), called the relative orientation partition. Then for each minutiae pair m̅, the index i or id(m̅) is defined as:

$$id ( m \text{?} ) ≐ 400 {i}_{d} + 40 {i}_{{ro}_{1}} + 4 {i}_{{ro}_{2}} + 2 i \text{?} + i \text{?}$$

$$\text{?} \text{indicates text missing or illegible when filed}$$

where the distance index i_{d}≐ [symbol] .idx(d(m̅), the first relative orientation index iᵣₒ_{₁}≐ [symbol] .dix(ro₁(m̅)) the second relative orientation index iᵣₒ_{₂}≐ [symbol] .idx(ro₂(m̅)), the first type index iₜ_{₁}≐m̅[0]t, the second type index iₜ_{₂}≐m̅[1]t. In this example, b=4000. It will be appreciated that the entropy e of the system is the number of non-trivial indices, wherein i∈1 is called trivial if id⁻¹(i)= [symbol] , else it is non-trivial. The security of the teachings herein lies in the entropy and a≤b. Moreover, it will be noted that an index is biometrically uniform if, for many minutia pairs drawn over many representative minutiae templates, each non-trivial index should account for a similar number of minutiae pairs.

It will be appreciated that the partition [symbol] and array of partitions [symbol] are fixed parameters. Moreover, the distance index i_{d} may be the UDI described herein and the first and second UAI may be the first and second relative orientation angle indices. Similarly, the first and second type of identifying data may be the first and second type indices as defined herein.

It will be appreciated that since differences in distances are greater with longer distances, the sub-intervals in the distance partition may be bigger for the longer distances. Since relative orientations tend to vary less the longer the distance, the angle intervals may be smaller the larger the distances. It follows that the angle and distance partitions may thus be related. In particular, the number of angle sub-intervals may depend on the particular distance. It is the number of angle sub-intervals since there is no reason relative orientation sub-intervals should be of different size within in any one relative orientation partition. In this regard, the distance partition D may have intervals of different lengths/sizes. The relative orientation partition may be an array of relative orientation partitions, indexed by the distance index.

The distance partition can be an indexed half-open partition D. The indexed basic-angle partition may be an indexed half-open partition of the interval [0, 360). The sub-intervals may be large. In some example embodiments, the distance intervals may be of length δ, and all relative orientation intervals may be of length ϵ.

The basic-angle partition can be an indexed half-open partition of the interval [0, 360).

An indexed angle partition A is determined by an indexed basic-angle partition which may be denoted as Â and a small positive angle denoted A.sh, where A.sh is strictly smaller than the length of any equivalence class of Â. Those skilled in the art will appreciate that different nomenclature used herein may refer to the same aspects, as the case may be.

In any event, the hasher as described herein is parametised by an indexed half-open distance partition D of the interval [0, d+1), where d is the maximum distance between two distinct minutiae drawn from real “real-world” templates. The hasher is further parameterised by the M-length, wherein M≐ [symbol] .res, array of relative angle partitions [symbol] . N may be defined to be max [symbol] [k].res:k=0, 1, . . . , M−1}. Each of may be simple, although perhaps each differing in resolution.

Differently defined, the method can comprise, for each minutiae tuple or n-tuple m, determining the index i or id (m) as follows:
(i)) for 0≤k≤n−2, define or determine:

$${i}_{d} [ k ] ≐ 𝒟 \text{?} idx ( d ( m \text{?} [ k , k + 1 ] ) ) ,$$

$${i}_{{ro}_{1}} [ k ] ≐ 𝒪 [ {i}_{d} [ k ] ] \text{?} idx ( {ro}_{1} ( m \text{?} [ k , k + 1 ] ) ) ,$$

$${i}_{{ro}_{2}} [ k ] ≐ 𝒪 [ {i}_{d} [ k ] ] \text{?} idx ( {ro}_{2} ( m \text{?} [ k , k + 1 ] ) ) ,$$

$$\text{?} \text{indicates text missing or illegible when filed}$$

called the k-th distance index, the k-th first relative orientation index and the k-th first relative orientation index, respectively, and for 0≤k≤n−1, determine or define:

$${i}_{t} [ k ] ≐ m \text{?} [ k ] \text{?} t ,$$

$$\text{?} \text{indicates text missing or illegible when filed}$$

called the k-th type index,
   (ii) define i[0] by

$$4 {N}^{2} \text{?} [ 0 ] + 4 N {i}_{{ro}_{2}} [ 0 ] + 4 {i}_{{ro}_{2}} + 2 i \text{?} [ 0 ] + {i}_{t} [ 1 ]$$

$$\text{?} \text{indicates text missing or illegible when filed}$$

(iii) recursively define i[k], for 1≤k≤n−1, by 2MN²i[k]+2N2ⁱ_{d}[k]+2N+iₜ[k+1]; and
(iv) determine or define the index id(m̅) as:

$$id ( m \text{?} ) ≐ i [ n - 1 ] .$$

$$\text{?} \text{indicates text missing or illegible when filed}$$

As described herein, this index is standard transformation invariant. It will be noted that the n−1th data is excluded since this is already implicit (consider the 2-dimensional case), and unnecessary class mismatch errors are avoided from being added.

With a standard transformation invariant notion of index, the present disclosure permits that the index is hidden and any correlations between indices are hidden, by hashing each index together with the user password and organizational salt, via hashing with the function H.

In one example embodiment, the method can comprise reducing the number of members of a family to include in the hashed template, that must be invariant under standard transformation. Ideally this may be a reduction to a single representative. By family fam (m) of distinct minutiae n-tuple m̅=<m₀, . . . , mₙ₋₁>, is meant the set of all distinct minutiae n-tuples over {m₀, . . . , mₙ₋₁}.

The method may comprise providing a choice function ch(⋅): [symbol] hu n. . . , [symbol] ⁿ, such that for all m̅∈ [symbol] ⁿ, and all n̅∈fam(m̅), ch(m̅)=ch(n̅). The method may comprise letting fam_unq(m̅) denote the set of all n̅∈fam(m̅), such that for all \hat{n}≠m̅′∈fam(m̅), id(m̅′)≠id(n̅). An n-tuple m is resolvable if fam_unq(m̅)≠ [symbol] .

In the case of the n-tuple which is resolvable, the choice function choice(m̅) may be a unique member of fam_unq(m̅) with the lowest index. Such a function must be a choice function. However, this reduces entropy by a factor of n!. To avoid this, the method comprises introducing a reduction-oracle orc(n,h) as a parameter, that takes a natural number n and a hash-digest, such as a unit-digest, as input, and (as) uniformly (as possible) outputs an integer in the interval [0, n).

Example 5: One such oracle is defined by orc(n, h)=h mod n, viewing the digest h as a large integer.

Consider the following choice function ch(m̅, s_{fr}, pw), which requires an additional organizational salt Str. Assuming that the n-tuple is resolvable.
1. Let Ī be the unique family identities id[fam_unq(m̅)) as a sequence in strictly increasing numeric order;
2. Let u=[Ī];
3. Let h≐H(Ī[D], s_{fr}, pw)
4. Let i≐orc(n, h); and
5. Define choice(m̅, s_{fr}, pw) to be the (unique) member of fam (m) with index i.

With families reduced in such a manner, the hashed template size is reduced by n!, while maintaining the entropy, without exposing the password by the inclusion of Ī[U] in step 2. The trade-off is a bet that index mismatch occurs for no member of the family, where the probability of mismatch grows with dimension.

It will be appreciated that the family of a minutia pair m̅, consist of m̅ and its co-pair co(m̅). The method may comprise reducing co-pairs by applying a suitable co-pair reduction function ch′. For a reducible minutiae pair m̅, the co-pair reduction function ch′ may be defined as follows:

$$( i ) if \overline{m} [ 0 ] \cdot t \neq \overline{m} [ 1 ] \cdot t ,$$

$${ch}^{′} ( \overline{m} ) ≐ \{ \begin{matrix}\overline{m} , & \overline{m} [ 0 ] \cdot t < \overline{m} [ 1 ] \cdot t \\ co ( \overline{m} ) , & otherwise ,\end{matrix}$$

$$( ii ) otherwise ,$$

$${ch}^{′} ( \overline{m} ) ≐ \{ \begin{matrix}\overline{m} , & id ( \overline{m} ) < id ( co ( \overline{m} ) ) \\ co ( \overline{m} ) , & otherwise ,\end{matrix}$$

The method can comprise processing a hashed digest with a Boolean oracle which outputs either true or false.

Example 6: A Boolean oracle is defined by orc′(h)=true iff the first bit of h=0.

For reducible m̅, define ch(m̅, s_{fr}, pw) by:

| | |
|---|---|
| | ch′ (m), orc′(H(min(id(rh), id(co(m))), sa, pw)) |
| {open oversize brace} | |
| | co(ch′(mo)), otherwise. |

The method can comprise, for each minutia pair m̅ in the selected pairs:
(i) determining the distance index i_{d} and the unit hash h as described above;
(ii) determining the distance remainder r_{d}≐rm_{D}(d(m̅), where, for any distance x, rm_{D}(x)≐x−b, where b is the greatest lower bound of the distance partition subinterval containing x;
(iii) determining h_{d} by combining id(m̅), pw and S_{rd}, converting the result to a byte array and hashing with the chosen cryptographically secure hash function H;
(iv) determining or defining s_{d}≐o_{d}(h_{d}), wherein o_{d}(⋅) is uniform full-hash-transformation, where a full-hash-transformation—is a mapping of the range of H into the real interval (−o.l, o.l) to □.res decimal points; for convenience f_{d}=o_{d}.res;
(v) determining or defining

$${r}_{d}^{′} \text{?} {r}_{d} + {s}_{d} , ;$$

$$\text{?} \text{indicates text missing or illegible when filed}$$

(vi) determining or defining

$${r}_{d}^{*}$$

to be the rounding of

$${r}_{d}^{′}$$

to f_{d} decimal places;
(vii) determining or defining the first relative orientation remainder rₒ_{₁}≐rmₒ_{_{[id]}}(ro₁(m̅)) where, for any angle partition A and angle θ, rm_{A}(θ) is defined analogously to ii. above, but taking care when an interval straddles 0;
(viii) determining or defining hoi by combining id(m̅), pw and sᵣₒ₁, converting the result to a byte array and hashing with the chosen cryptographically secure hash function H;
(ix) determining or define sₒ_{₁}≐oₜₒ(hₒ_{₁}) where oᵣₒ(⋅) is a uniform half-hash-transformation into the real interval [0, 360), where a half-hash-transformation o is a mapping of the range of H into the real interval [0, □,l) to o.res decimal points; for convenience
(x) determining or defining

$${r}_{{o}_{1}}^{′} = {r}_{{o}_{1}} + {s}_{{o}_{1}} ;$$

(xi) determining or defining

$${r}_{{o}_{1}}^{′} = std ( {r}_{{o}_{1}}^{′} ) ,$$

wherein std(θ) is the function that converts any angle θ to its equivalent value in the interval [0, 360);
(xii) determining or defining

$${r}_{{o}_{1}}^{⋆}$$

to be the founding of i to iₒ decimal places;
(xiii) determining or defining the second relative orientation remainder rₒ_{₂}≐rmₒ_{_{[id]}}(ro₂(m̅));
(xiv) determining or defining hₒ₂ by combining id(m̅) pw and sᵣₒ₂, converting the result to a byte array and hashing with the chosen cryptographically secure hash function H;
(xv) determining or defining sₒ_{₁}≐□ₘ(hₒ_{₁});
(xvi) determining or defining

$$r \text{?} ≐ {r}_{{o}_{2}} + \text{?} ;$$

$$\text{?} \text{indicates text missing or illegible when filed}$$

(xvii) determining or defining

$$r \text{?} ≐ std ( r \text{?} ) ;$$

$$\text{?} \text{indicates text missing or illegible when filed}$$

(xviii) determining or defining

$$r \text{?}$$

$$\text{?} \text{indicates text missing or illegible when filed}$$

to be the rounding of r̅to fₒ decimal places; and
(xix) determining or defining an object h with properties

$$\text{?} ≐ \text{?} ,$$

$$h \text{?} srd ≐ {r}_{d}^{⋆} , h \text{?} ≐ r \text{?} ,$$

$$and$$

$$h \text{?} ≐ {r}_{{o}_{2}}^{⋆} \text{?} ,$$

$$\text{?} \text{indicates text missing or illegible when filed}$$

determined by m̅ and pw.

In other words, the method can comprise adding d(m̅), ro₁(m̅), and ro₂(m̅), or rather, their remainders modulo their sub-intervals, or rather these remainders shifted by some value determined by a digest transformation of the hash of id(m̅), the password pw, and the three additional salts.

It will be appreciated that the half-hash-transformation oof length o.l and resolution o.r. is a function from the digests of H into the real interval [0, o.l) to o.r. decimal places. In other words, a half-hash-transformation o of length o.l≐n and resolution r denoted o.res, is a function from the domain of H into those real numbers in the interval [0, n) with at most r decimal points.

A full-hash-transformation □ of length □.l≐n and resolution o.r. is a function from the digests of H into the real interval (−o.l/2, o.l/2) to o.r. decimal places.

The method can comprise collecting all the sharp unit-hashes into a set, with optional co-pair reduction, called the hashed template determined by minutiae template T and password pw.

The method can comprise providing the distance partition D with sub-intervals of differing lengths. The method may comprise determining the particular relative orientation partition based on the distance index. In other words, the particular relative orientation partition is based on the distance index.

In one example embodiment, the method can comprise:
re-defining the distance remainder as r_{d}≐rm_{D}(d(m̅), C_{d}|i_{d}|), wherein i_{d} is the distance index, C_{d} is an array of compactification percents, which are real numbers greater and equal to 0 and strictly less than 1, called the distance compactification, and where, for any distance and compactification percent d c, rm_{D}(d,c)≐rm_{D}(I.cpt(d, c)) wherein I is the distance partition sub-interval containing d, and where, I.cpt(d, c) is the compactification of d into interval I, defined by I.cpt(d, c)≐d+c(m−d), wherein m is the midpoint of the interval I;
re-defining the first relative orientation remainder as rₒ_{₁}≐rm [symbol] _{[id]}(ro₁(m̅), Cᵣₒ[i_{d}]), wherein Cro is an array of compactification percents, called the relative orientation compactification, wherein rm [symbol] _{_{[id]}}(θ, c) is defined analogously to [symbol] (d, c) above but taking care with the angle subinterval containing 0; and
re-defining the second relative orientation remainder as (rₒ_{₂}≐ [symbol] _{[id]}(ro₂(m̅), Cᵣₐ[i_{d}]); wherein the sharp unit-hashed obtained in this fashion are referred to as compact unit-hashes.

By way of example, for an interval [0, 100]. A 50% compactification percent should map into [25, 75], a 25% compactification percent should map into [12.5, 87.5], a 75% compactification should map into [37.5, 62.5], while a 0% compactification maps into [0, 100].

In the case that all distance and relative orientation compactification percents are precisely 1, this method coincides with the method described above. Moreover, it will be appreciated that the C_{d} and Cᵣₒ may be parameters to the method. Moreover, the salts sᵣ, s_{rd}, sᵣₒ₁, and sᵣₒ₂ may all be organisational salts, which are fixed. In addition, □_{d} is a fixed parameter.

It will be appreciated that to perform cycle checking, the method may comprise labelling/numbering/ordering minutiae of a minutia template; and recording the label of the minutia that comprise the hashed pair. The method may comprise labelling/numbering/ordering the minutiae in the minutia template prior to hashing.

In one example embodiment, the method can comprise, for each sharp unit-hash, h, the method may comprise:
adding two properties to the sharp unit-hash, namely:

$$h \text{?} i = i ( m \text{?} [ 0 ] ) ,$$

$$h \text{?} j = i ( m \text{?} [ 1 ] ) ,$$

$$\text{?} \text{indicates text missing or illegible when filed}$$

wherein a random bijection I, called the random ordering, from T onto {0, 1, . . . , [T]−1}, and wherein the new object is referred to as the labelled unit-hash.

The method may comprise forgetting the random ordering; and collecting the labelled unit-hashes into a labelled hashed template.

In another example embodiment, the method can comprise, for each selected pair the method may comprise:
adding a property, h.P to the sharp-unit hash, h, which is an array of length T.len where, for each 0≤k<T.len, h.P[k] is determined or defined by:
   (a) determining <x,y=T[k](m̅), wherein each T′[k](⋅) is a function called a translation determinant mapping a minutiae pair to an absolute point;
   (b) determining or defining hₓ by combining I, pw, and organisational salt sₓ[k], converting the result to a byte array and hashing with a cryptographically secure hash function H;
   (c) determining or defining sₓ=□_{TX}(hₓ), wherein □_{TX} is a uniform full-hash-transformation, for convenience fₓ=o_{TX}.res;
   (d) determining or defining x′≐x+sₓ;
   (e) determining or defining x* to be the rounding of x′ to fₓ decimal places;
   (f) determining or defining h_{y} by combining i, pw and organizational salt s_{y}[k] converting the result to a byte array and hashing with the chosen cryptographically secure hash function H,
   (g) determining or defining define sₙ=oᵣᵣ(h_{y}), wherein o_{TY} is a uniform full-hash-transformation; for convenience
   (h) determining or defining y′≐y+s_{y};
   (i) determining or defining y* to be the rounding of y′ to f_{y} decimal places; and
   (j) determining or defining h.P[k]≐(x*, y*);
adding a property h.A to the sharp unit-hash, h, which is an arrange of length R.len, wherein for each 0≤k<R.len, h.A[k] is determined or defined by:
   (a) determining 0=R[k](m̅), wherein each R[k](⋅) is a function called a rotation determinant mapping a minutiae pair to an absolute angle;
   (b) determining define h_{θ} by combining i, pw and organizational salt sₐ[k], converting the result to a byte array and hashing with the chosen cryptographically secure hash function H;
   (c) determining or defining, s_{D}=O(h_{θ}) wherein o_{R} is a uniform half-hash-transformation into [0, 360), wherein f_{D}=R.res;
   (d) determining or defining θ′≐θ+s_{θ};
   (e) determining or defining θ̅≐std(θ′);
   (f) determining or defining θ* to be the rounding of θ̅′ to f_{α} decimal places; and
   (g) determining or defining tₒ.A[k]≐θ′, which is an object referred to as an absolute unit-hash.

It will be appreciated that the absolute hashed template may add the following parameters to the compact hashed template, or may extend the compact hashed template, with the following parameters: an array T of translation determinants; an array R of rotation determinants, a uniform full-hash-transformation o_{TX}, a uniform full-hash-transformation o_{TY}, and a uniform half-hash-transformation o_{P} into [0, 360).

The salts Sₓ and S_{y} may be a T-length arrays of distinct salts, wherein the salt Sa may be a R-length array of distinct salts.

The method can comprise collecting all the absolute unit-hashes into an absolute hashed template.

For completeness, a translation determinant p(⊇) may be a function mapping a minutiae n-tuple m̅ to a point, such that, for two minutiae n-tuples m̅ and n̅, p(n̅)−p(m̅) realises some aspect of the translations from m̅ to n̅. In other words, p maps m̅ to an absolute point. On the other hand, the rotation determinant α(⋅) may be a function mapping a minutia n-tuple m̅ to an angle, such that, for two minutia n-tuples m̅ and n̅, α(n̅)−α(m̅) realises some aspect of rotation from m̅ to n̅. In other words, a(m̅) maps m̅ to an absolute angle.

The arrays T of translational determinants and R of rotational determinants, o_{TX}, □_{TY}, and o_{R} are parameters of the method described herein.

According to another aspect of the disclosure, there is provided a processor-implemented method for comparing two hashed templates, H and K, to determine a non-negative real value score such that if the hashed templates where generated from different passwords or different salts, then the score is 0 with cryptographically high probability, otherwise, if generated from the same password and salt, the score increases the better the determining fingerprints match, wherein the score (H, K) is determined or defined as:

if H∩K= [symbol] then is score is defined to be 0, otherwise, the score is determined by standard statistical techniques, comparing the size of H∩K with the sizes of H and K, together with experimentally obtained statistical data, such as expected sizes of H∩K for the same finger and for different fingers, etc. very simple example is defining the score to be |H∩K|/ag(|H|, |K|.

It will be understood that matching may essentially be a test for unit-digest equality, which, with cryptographic probability, is equivalent to testing for index equality.

In the example embodiment wherein, the hashed templates H and K are compact or sharp hashed templates, the score (H, K) is determined by, or defined as follows:
for each unit hash h∈H and unit hash k∈K, define a unit_match (h, k) if:

$$h \text{?} dg = k \text{?} dg ,$$

$$\vert h \text{?} srd - k \text{?} srd \vert < ϵ ,$$

$$\vert h \text{?} - k \text{?} \vert < ϵ , and$$

$$\vert h \text{?} - k \text{?} \vert < ϵ ,$$

$$\text{?} \text{indicates text missing or illegible when filed}$$

and
calculating: unit C=h∈H:unit_match(h,k) for some k∈K, otherwise the score is determined by standard statistical techniques, comparing the size of C with the sizes of H and K, together with experimentally obtained statistical data, such as expected sizes of C for the same finger and for different fingers, etc., one very simple example is defining the score to be |C|/avg(|H|, |K|).

In the example embodiment wherein, the hashed templates H and K are labelled hashed templates, the score (H, K) is determined by, or defined as follows:
determining L={<<h.i, h.j>, <k.i, k.j>>:h∈H, k∈K, unit_match(h, k)}, and letting G be the set of all the first pairs of L, and let H be the set of the second pairs,
observing that G (resp. H) may be viewed as a graph whose elements are the minutiae of H (resp. K) as identified by their random orderings, with an edge linking two minutiae if that minutiae pair matches a “pair” in K (resp.K), in which case L maps a matching edge of G to the associated matching edges of H;
if L is empty then the score is defined to be 0, otherwise, the method may comprise using standard graph theoretic techniques to find the maximal cycles of length 3 or more of graph G that map via L to cycles in H of the same length, called the maximal matching cycles; and
generating the score using standard statistical techniques, comparing a length-weighted tally of the maximal matching cycles with the sizes of |H| and |K|, together with experimentally obtained statistical data regarding expected values for positive and negative matches, etc.

In the example embodiment wherein, the hashed templates H and K are absolute hashed templates, the score (H, K) is determined by, or defined as follows:
(A) a sanity check is performed to ensure that for every h∈H and h∈K, h.P.len=nₚ=h.P.len and h.A.len=nₚ=h.A.len, for some fixed nₚ and nₐ, and if not, the score is defined to be 0, otherwise,
(B) for each h∈H and k∈K, define unit_match*(h, k) if:
   (i) unit_match (h, k);
   (ii) the translations {h.P[i]−k.P[i]:0≤i>nₚ−1} all lie within an acceptable tolerance of each other; and
   (iii) the rotations {h.A[i]−k.A[i]:0≤i<nₐ−1} all lie within an acceptable tolerance of each other;
(C) if there exists no h∈H and no k∈K such that unit_match*(h, k), then the score is defined to be 0, otherwise;
(D) for each h∈H and k∈K such that unit_match*(h, k).
   (i) define tₕₖ as some representative value of the set of the (similarly valued) translations {h.P[i]−k.P[i]:0≤i<nₚ−1}, such as taking the average,
   (ii) define rₕₖ as some representative value of the set of the (similarly valued) rotations {h.A[i]−k.A[i]:0≤i<nₐ−1}, such as taking the average,
(E) use a statistical clustering technique to divide the pairs <h, k∈H×K, with unit_match*(h, k). into clusters with respects to translation tₕₖ and rotation rₕₖ. i.e., each cluster contains pairs with similar translation and rotation; and
(F) determining the score via standard statistical techniques, comparing the size of the largest cluster, with the sizes of H and K, together with experimentally obtained statistical data regarding expected values for positive and negative matches, etc.

The translational and rotational tolerances are parameters of the method described herein.

The method can comprise, for a distinct minutiae n-tuple, determining a unique candidate n-tuple from the n! permutations of an, for inclusion in the hashed template, provided at least one permutation has an index distinct from the indices of the other permutations, by:
(a) ordering the labels of all permutations of the tuple and removing any labels that do not appear only once, obtaining the ordered unique labels list (OULL);
(b) combining the first label of the OULL, an organisational salt specifically for this purpose, and the user password into a data unit, and using cryptographically secure hash function to hash this combined data unit, obtaining the choice digest;
(c) using a deterministic oracle to determine a position (index) into the OULL, from the choice digest and the size of the OULL only;
(d) finding the index in the OULL at this position; and
(e) choosing the unique permutation with this index.

The method can comprise, for a distinct minutiae pair <m, n> determining which of the pair or its reverse >n, m> to include in the hashed template, provided the pair and its reverse have distinct indices, as follows:
(a) a simple choice is determined as follows:
   (i) if m and n have different types, then, if m is a bifurcation, then the simple choice is <m, n> otherwise, the simple choice is <n, m>; and
   (ii) otherwise, if the label of <m, n> is comparatively less than the label of <n, m>, then the simple choice is <m, n>, otherwise, the simple choice is <n, m>;
(b) combining the least (say) of the indices of <m, n> and <n, m>, an organizational salt specifically for this purpose, and the user password into a data unit, and use the cryptographically secure hash function to hash this combined data unit, obtaining the choice digest;
(c) using a deterministic oracle that returns either true or false, from the choice digest only; and
(d) if the oracles chose true, the simple choice is selected or chosen, otherwise the reverse of the simple choice is selected or chosen.

According to another aspect of the disclosure, there is provided a system comprising:
at least one processor; and
a memory device coupled to the at least one processor, wherein the memory device is a non-transitory memory device which stores non-transitory processor-executable instructions which when executed on the at least one processor causes the at least one processor to perform any one of the methods, or method steps, as described above.

According to another aspect of the disclosure, there is provided a server comprising at least one processor and a database communicatively coupled to the at least one processor, wherein the at least one processor is configured to implement at least some of the methods, or method steps, described herein.

According to another aspect of the disclosure, there is provided an endpoint computing device comprising at least one processor and a memory device coupled to the at least one processor, wherein the memory device stores a software application having instructions which when executed by the at least one processor is configured to implement at least some of the methods, or method steps, described herein.

The endpoint computing device may be a smart device such as a smartphone.

According to yet another aspect of the disclosure, there is provided a non-transitory computer executable storage medium storing computer software having instructions which, when executed on at least one processor, causes the at least one processor to implement at least some of the methods, or method steps, described herein.

It will be appreciated that aspects described herein with respect to one example embodiment of the disclosure may be apply mutatis mutandis to another aspect of the disclosure described herein.

### BRIEF DESCRIPTION OF THE DRAWINGS

FIG. 1 shows a schematic block diagram of a system in accordance with an example embodiment of the invention;

FIG. 2 shows a flow diagram of a method in accordance with an example embodiment of the invention;

FIG. 3 shows another flow diagram of a method in accordance with an example embodiment of the invention;

FIG. 4 shows another flow diagram of a method in accordance with an example embodiment of the invention;

FIG. 5 shows another flow diagram of a method in accordance with an example embodiment of the invention;

FIG. 6 shows another flow diagram of a method in accordance with an example embodiment of the invention;

FIG. 7 shows another flow diagram of a method in accordance with an example embodiment of the invention;

FIG. 8 shows another flow diagram of a method in accordance with an example embodiment of the invention;

FIG. 9 shows an illustration of at least a pair of minutia points of an n-tuple in accordance with an example embodiment of the invention;

FIG. 10 shows an illustration of a distance partition and associated distance equivalence classes in accordance with an example embodiment of the invention;

FIG. 11 shows an illustration of an angle partition and associated orientation angle equivalence classes in accordance with an example embodiment of the invention;

FIG. 12 shows a schematic block diagram of an endpoint computing device in accordance with an example embodiment of the invention; and

FIG. 13 shows a schematic block diagram of a server in accordance with an example embodiment of the invention.

### DETAILED DESCRIPTION OF THE DRAWINGS

The following description of the disclosure is provided as an enabling teaching of the invention. Those skilled in the relevant art will recognise that many changes can be made to the embodiment described, while still attaining the beneficial results of the present disclosure. It will also be apparent that some of the desired benefits of the present disclosure can be attained by selecting some of the features of the present disclosure without utilising other features. Accordingly, those skilled in the art will recognise that modifications and adaptations to the present disclosure are possible, and may even be desirable in certain circumstances, and are a part of the present disclosure. Thus, the following description is provided as illustrative of the principles of the present disclosure and not a limitation thereof.

It will be appreciated that the phrase “for example”, “such as”, and variants thereof describe non-limiting embodiments of the presently disclosed subject matter. Reference in the specification to “one example embodiment”, “another example embodiment”, “some example embodiment”, or variants thereof means that a particular feature, structure or characteristic described in connection with the embodiment(s) is included in at least one embodiment of the presently disclosed subject matter. Thus, the use of the phrase “one example embodiment”, “another example embodiment”, “some example embodiment”, or variants thereof does not necessarily refer to the same embodiment(s).

Unless otherwise stated, some features of the subject matter described herein, which are, described in the context of separate embodiments for purposes of clarity, may also be provided in combination in a single embodiment. Similarly, various features of the subject matter disclosed herein which are described in the context of a single embodiment may also be provided separately or in any suitable sub-combination.

The headings used herein are for organizational purposes only and are not meant to be used to limit the scope of the description or the claims. For brevity, the word “may” is used in a permissive sense (i.e., meaning “having the potential to”), rather than the mandatory sense (i.e., meaning “must”).

The words “include”, “including” and “includes” and the words “comprises”, “comprising”, and “comprises” mean including and comprising, but not limited to, respectively.

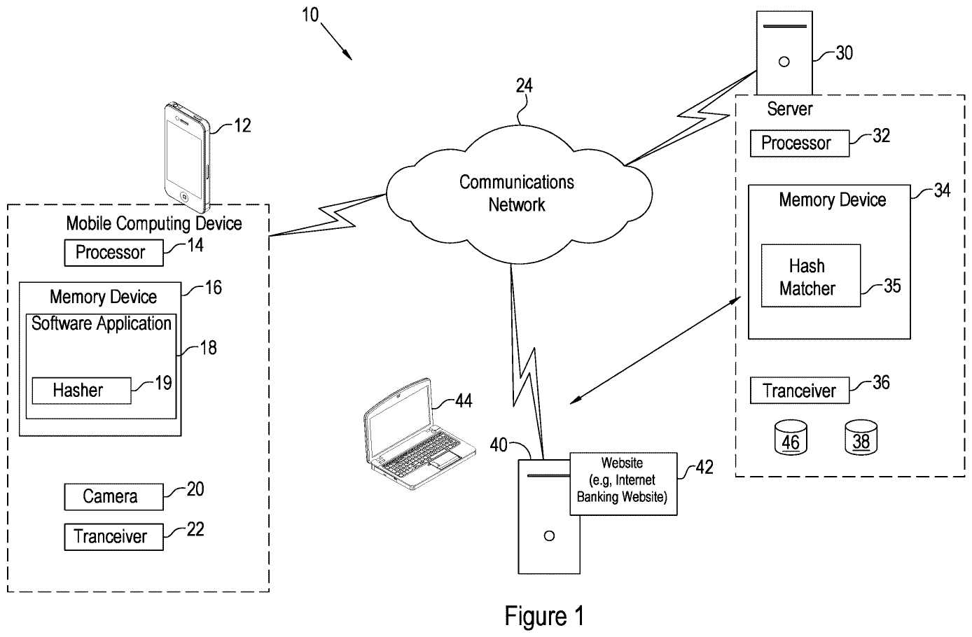

Referring to FIG. 1 of the drawings a system in accordance with an example embodiment of the disclosure is generally indicated by reference numeral 10.

The example embodiment of the system 10 is described with reference to a financial institution such as a bank wishing to enhance the security of their online or digital banking systems, by introducing a degree of proof-of-life using biometrics, over and above existing password security protocols. Neither the bank nor the user wishes to transmit or store biometric data for personal security reasons. Neither would they like to transmit nor store passwords. The present disclosure provides a means to enhance banking security without having to transmit or store passwords but should not be seen as a limitation of the application of the teachings disclosed herein. However, this is an example embodiment and should not be seen as a limitation of the application of the teachings disclosed herein, or as claimed herein.

Reference will be made herein to biometrics is in the form of fingerprints. However, it will be appreciated by those skilled in the art that the teachings herein may be extended mutatis mutandis to other biometrics.

The system 10, or components thereof, can be a standalone and communicatively coupled to a banking system of a bank. Instead, or in addition, the system 10, or components thereof may be part of an online or digital banking system of a bank.

The system 10 includes an endpoint computing device in the form of a mobile computing device 12, such as a mobile phone or smartphone, a tablet computer, a personal digital assistant, a wearable computing device, a portable media player, a computing device of a vehicle, etc.

The mobile computing device 12 includes a processor 14, and a memory device 16 coupled thereto, wherein the memory device 16 stores non-transitory processor-executable instructions and data corresponding to one or more software applications (“apps”). For example, the mobile device 12 can include (i.e., stored in the memory device 16) a fingerprint software application 18 which directs the operations of the mobile computing device 12 as described herein. The processor 14 is configured to execute the processor-executable instructions corresponding to the app 18 and as such reference to operations of the app 18, and components thereof, may be understood to mean operations by the processor 14 or mobile computing device 12 under instructions associated with the app 18, and components thereof. Thus, the processes or methods ascribed to the app 18 can be interchangeably ascribed to the processor 14, and the mobile computing device 12, as the case may be.

The mobile computing device 12 also includes a camera 20, for example, a conventional complementary metal oxide semiconductor (CMOS) camera, or the like to capture images, and a communications module in the form of a wireless transceiver 22 configured to communicate with one or more other devices such as servers over a communications network 24.

The communications network 24 can comprise one or more different types of communication networks. In this regard, the communication networks may be one or more of the Internet, a local area network (LAN), a wide area network (WAN), a metropolitan area network (MAN), various types of telephone networks (e.g., Public Switch Telephone Networks (PSTN) with Digital Subscriber Line (DSL) technology) or mobile networks (e.g., Global System Mobile (GSM) communication, General Packet Radio Service (GPRS), Code Division Multiple Access (CDMA), and other suitable mobile telecommunication network technologies), or any combination thereof. It will be noted that communication within the network may achieved via suitable wireless or hard-wired communication technologies and/or standards (e.g., wireless fidelity (Wi-Fi®), 4G, long-term evolution (LTE™), WiMAX, 5G, and the like).

The system 10 can comprise a plurality of mobile computing devices 12 but only one is illustrated for ease of illustration and description.

The software application 18 may be, or may be part of, a mobile banking application that is specific to a financial institution, such as a specific bank or a specific credit union. In other example embodiments, the software application 18 may be a bespoke application which handles the security of the transactions of a conventional banking application. Whatever the case, it will be appreciated that the software application 18, as it operates on the mobile computing device 12, forms part of the system 10 as described herein. The software application 18 may have a suitable graphical user interface (GUI) with which a user may interact with the same. Moreover, it will be understood that the software application 18 can control at least some of the functionality of the mobile computing device 12 for the purposes of enabling the methodology described herein, for example, the software application 18 may be configured to access the camera 20 of the mobile computing device as will be described below.

The user of the mobile device 12 can download the software application or “app” 18 from an online software application store. In some example embodiments, for mobile banking, the software app 18 can be configured to perform conventional banking operations such as an account balance operation, a fund transfer operation, a credit or debit card payment operation, a deposit operation, a withdrawal operation, a bill pay operation, a transaction history operation, and the like.

The system 10 also includes a server, for example, a back-end server 30. Though one server 30 is illustrated, it will be appreciated that in some example embodiments, the system 10 can comprise multiple back-end servers 30, for example, distributed across different geographic locations but in communication with each other, and the mobile computing device 12, via the communications network 24, to support the software application 18 and the operation of the system 10 as described herein.

As alluded to above, the back-end server 30 may form part of a digital banking system of a bank. However, in other example embodiments, the server 30 may be a standalone server which is in communication with a digital system of a bank to provide the functionality described herein, particularly to identify, authorise, and/or validate a user based on their fingerprints.

The back-end server 30 includes a processor 32 and a memory 34 that stores non-transitory processor-executable instructions to perform one or more of the operations described herein. The back-end server 30 also includes a transceiver 36 configured to communicate with one or more devices, such as the mobile computing device 12, or a third-party server, via the communication network 24. The server 30 can communicate with mobile computing devices 12 via a suitable transport layer security protocol. In this way, any communication between the device 12 and the server 30 may be inherently encrypted and secure but may still be prone for hacking as will be understood by those skilled in the art.

For completeness, it will be appreciated that in some example embodiments, the system 10 may also include a web server 40, which may be one or more servers, for example, communicatively coupled to, and distributed across, the communications network 24. The web server 40 may be configured to host a suitable website 42 such as an internet banking website.

The website 42 can deliver content that is formatted for presentation on the mobile computing device 12. Instead, or in addition, the website 42 can deliver content that is formatted for presentation on a desktop or laptop computer, rather than a mobile version of such content that is formatted for presentation on the mobile computing device 12. It follows that, as is the case in many conventional online banking websites, the website 42 may typically provide a suitable graphical user interface (GUI) and may be used by users at computers, for example, a laptop computer 44, to log in to their bank's website to access their bank accounts stored as secured data in a secured database 46 associated with the bank and perform internet banking functions such as making transactions such as transfers, viewing account balances, transaction histories, and credit or debit card information.

In the system 10 as described herein, a user is permitted to access their bank accounts stored securely in the database 46, to perform any of the banking operations described herein, via their software application 18 on their mobile computing device 12, or via the website 42 being accessed by their laptop computer 44 or the mobile computing device 12.

The web server 40 may be provided by the server 30 and/or may form part of the server 30. In other example embodiments, the web server 40 may be a standalone server communicatively coupled to the database 46, either directly or via the communications network 24 using a secure connection such as a transport layer security protocol.

The mobile computing device 12 and the server 30 operate in concert to permit a user to gain access to the secured data stored in the secured database 46 either via the software application on the mobile device 12 or via the website 42 accessible via the mobile computing device 12 or the laptop 44 over the communications network 24. In particular, the mobile device 12 and the server 30 operate to only provide access to the secured data stored in the secured database 46 upon identification, authentication, or verification of users based on their biometrics, for example, their fingerprints.

Reference to “fingerprints” herein may be actual fingerprints of a user, observable or visual images of a fingerprint which may be contained in a photograph, a fingerprint scan obtained by a conventional fingerprint scanner, or a conventional ink fingerprint of a user which corresponds to an actual fingerprint of a user, or actual fingerprints of the user. This may be depending on the context.

As alluded to above, there are drawbacks with conventional fingerprint scans, or the like being used for purposes of biometric identification, verification, or authentication. In this regard, in the system 10 described herein, the app 18 conveniently comprises a hasher 19 which is configured to hash fingerprint data associated with, representative of, or indicative of, the user's fingerprint with a unique user password and an organisational salt, for example, a salt uniquely associated with the bank providing the bank accounts stored in the secured database 46, using a cryptographically secure hashing function, such as a SHA-256 hash or hashing function, to generate a hashed template which may be a) enrolled to the system 10 as an enrolled hashed template and associated with the user by way of a unique user identifier; and/or b) used as a probed hashed template to the system 10 to determine a match as described herein.

In this way, it is not conventional fingerprint minutia templates but probed hashed templates associated with users that are seeking to be one or more of being identified, verified, and authenticated that are transmitted and compared to enrolled hashed templates, or are probed, to determine whether the users may access their bank accounts stored in the secured database 46. The system 10 serves to enhance security by removing or reducing threat of fingerprint minutia templates being intercepted during transmission for user identification, verification, or authentication. This is because, though undesirable, any transmitted hashed template which is intercepted may be meaningless, in themselves, to a cyber attacker or hacker whereas a fingerprint minutia template may be used to re-create a fingerprint of the user. Notwithstanding, the compromise of a single hash is still a serious problem, since the hash must be revoked and the user re-enrolled with a new password. The compromise of all the hashes of an organization is still a catastrophic event, in that all hashes must be revoked, new salts chosen, and all users re-enrolled. What can be ensured however, is that the revoked compromised hashes cannot be replayed, and that provided the passwords are strong, any stolen hashes cannot be used to recover passwords nor useful fingerprint information.

The organisational salt may be specifically associated with an organisation, for example, the bank or system 10 and may be part of the data which is downloaded with the app 18 and stored in the memory device 16. The salts are long random strings/byte-arrays, which once chosen, should never change, since changing salts requires full re-enrolment as hashes generated with different salts will never match.

It will be appreciated that the salts described herein are only used, and known, by the hasher 19, and are not known to hash matchers. The organizational salts are required at the point of hashing, which is often via a public device/API.

To use the system 10, a user must enroll their fingerprint/s to the system 10 for future identification, verification, or authentication, in this way it is only enrolled users that may be matched. Typically, the hashing referred to herein is for purposes of enrolling a user to use the system, or for probing, i.e., to identify, verify and/or authenticate the user to access the database 46 is done on the mobile computing device 12 by way of the software application 18 and is transmitted for one or more of identification, verification, and identification to the server 30 over the communications network as will be discussed below.

The server 30 typically comprises a database 38 which stores a plurality of enrolled hashed templates associated with enrolled users. The enrolled user is typically a human client of the bank or a human representative of a client of the bank that has been enrolled to use their fingerprint/s to access the secure database 46 in a manner described herein.

The enrolled hashed templates stored in the database 38 can be associated with unique user identifiers associated with the users. The unique user identifiers may be non-biometric identifiers and may be user selected or system generated usernames, a user's name and/or surname, a user's identification number or passport number, or any other deterministic additional user specific or identifying data serving to identify the users, in addition to their fingerprints, for example, their first or last names, identity numbers, etc. The user identifiers may map the associated enrolled hashed templates to the associated secure user accounts stored in the secured database 46.

In some example embodiments, the databases 46 and 38 can be the same database, or may be segmented into multiple databases communicatively coupled, for example, across the network 24, storing data as described herein. Moreover, in some example embodiments, the hashed templated may be stored in the database 38 without any user identifiers, for example, a probed hashed template is compared with a plurality of stored hashed templates to determine a match.

The memory device 34 of the server 30 typically stores a software application comprising a hash matcher 35 which has processor-executable instructions which directs the operations of the processor 32 in a manner described herein to at least compare two hashed templates to determine a match. The processor 32 is configured to execute the processor-executable instructions stored in the memory device 34 corresponding to the hash matcher 35 and as such reference to operations of the hash matcher 35 may be understood to mean operations by the processor 32, or the collective server 30. Thus, the processes or methods ascribed to the hash matcher 35 may be interchangeably ascribed to the processor 32, and the server 30. Similarly, other method steps described herein may be ascribed to the server 30 though it may be the processor 32 operating under instruction of the processor-executable instructions to achieve the steps or processes described herein.

The processor 32 is communicatively coupled to the database 38 and is configured, under instruction of the hash matcher 35, to receive a probed hashed template; and compare the same with one or more enrolled hashed templates stored in the database 38 to determine a match, wherein the probed hashed template comprises a hash, with the suitable hashing function, of a probed user password, the salt, and fingerprint data associated with a fingerprint of a probed user.

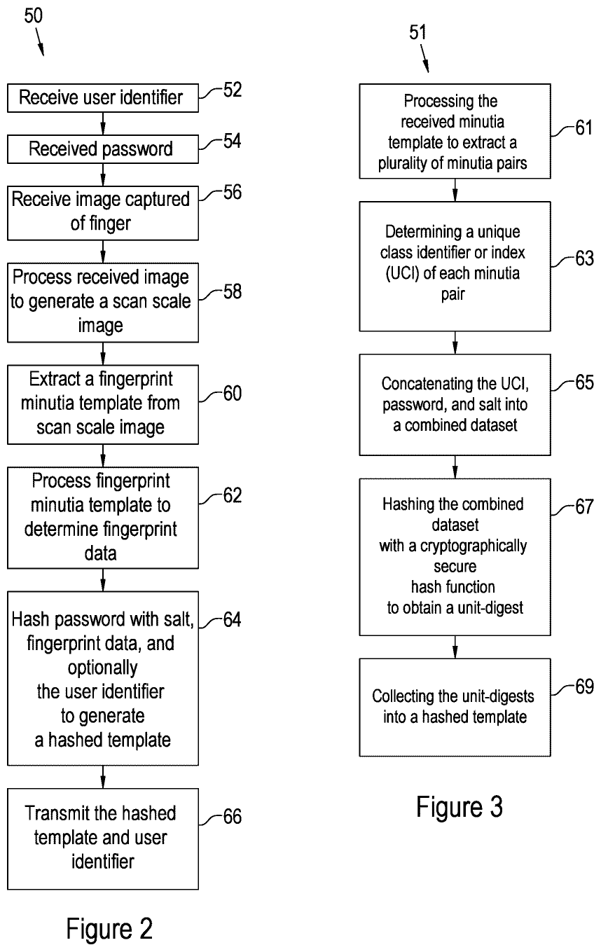

Operation of the system 10 will be described in greater detail with reference to FIGS. 2 to 8 of the drawings which illustrate flow diagrams of methods in accordance with an example embodiment of the invention. Though the methods illustrated and described are done so in relation to the system 10, it will be appreciated that the methods may be applied, mutatis mutandis, to other systems not illustrated or discussed herein. Moreover, it will be understood that variations not illustrated or discussed may be evident to those skilled in the art based on the disclosure herein and should not detract from teachings of the invention disclosed herein.

Referring to FIG. 2 of the drawings where a flow diagram of a method in accordance with an example embodiment of the disclosure is generally indicated by reference numeral 50. The method 50 serves to enhance security of online interactions such as online banking transactions as discussed herein.

A user of an online banking service must first enroll themselves for subsequent matching before being able access or log in to their bank account stored in the secure server 46. In this regard, the user uses their app 18 on their mobile computing device 12 to perform the method steps described in FIG. 2 to generate the hashed template for either enrolment or probing to gain access to their account.

In particular, the user may be prompted via the app 18 for various details ahead of in-app processing of these details in a manner described herein. In response to said prompting such as prompting the user for their user identifier, password and finger image, the method 50 comprises:
receiving, at block 52, a user identifier, which may be a username or user identification number in the form of a character string, alphanumeric string, numeric string, or combination thereof of the user;
receiving, at block 54, a user password, which may be a unique user selected password associated with the user in the form of a character string, alphanumeric string, numeric string, or combination thereof; and
receiving, at block 56, a photograph or image of the user's finger captured by the camera 20 of their mobile computing device 12, wherein the photograph or image is a conventional photograph or image captured by the camera 20 which has at least one finger, and thus the fingerprint, of the user in a captured field of view.

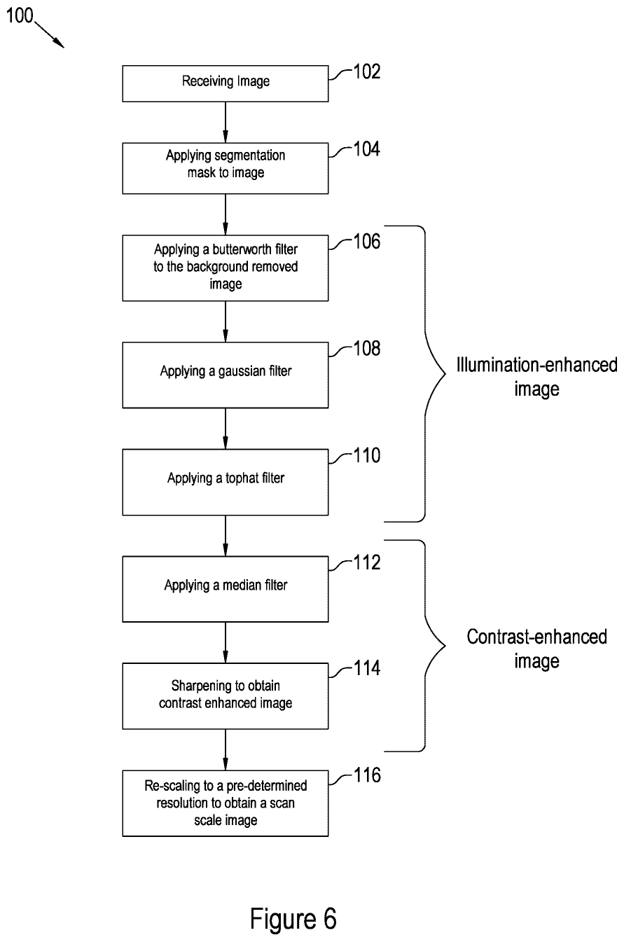

The method 50 comprises processing the received image, at block 58 at the mobile computing device 12 by way of the app 18, to generate a scan scale image of the fingerprint. The scan scale image of the fingerprint may typically mimic or reproduce an image of the fingerprint which may be captured using conventional contact-based fingerprint scanners such as conventional capacitive fingerprint scanners. Instead, or in addition, it will be appreciated that the scan scale image may correspond to or approximate a conventional ink-based fingerprint. The method step 58 may be expanded upon herein with reference to FIGS. 6 to 8 of the drawings and may be regarded as a contactless acquisition of the user's fingerprint.

The method 50 then comprises extracting a fingerprint minutia template, at block 60 with the hasher 19, from the generated scan scale image. This step may be a conventional step used to extract fingerprint minutia templates from conventional scan scale images acquired during contact-based fingerprint acquisition techniques. It follows that the fingerprint minutia template extracted in this fashion can be substantially similar to fingerprint minutia templates extracted from contact-based scan scale images.

The method 50 comprises processing the fingerprint minutia template, at block 62, to determine the fingerprint data, by determining classes of at least pairs of minutiae in the minutia template, wherein the classes partition the minutia template based on one or more attributes of the minutiae, or the pairs of minutiae, which are rotationally and translationally invariant, and wherein the fingerprint data is representative of the determined classes.

The method comprises hashing, at block 64, the determined fingerprint data, the received user password, and a salt which is specific to the organisation, which in this case is a bank, with a cryptographically secure hashing function to generate the hashed template.

The system 10 described herein is partially vulnerable to the common password attack, in the sense that if the attacker has access to the entire enrolled hashed template database 38, they can recognize which templates derive from the same password. While the hashed templates reveal little or no useful information in such cases, a common password is typically a weak password, thus suggesting to the attacker which hashes are best for a weak password attack.

In this regard, the method 50 can comprise concatenating additional fixed user specific information, such as the user identifier, to the actual user password, to generate a stronger user password; and using the stronger user password as the actual password passed to the hasher 19. This rules out (if the additional information is the user identifier or user identifying information) or reduces (if the additional information is not the user identifier or user identifying information) the possibility of identifying hashed templates with the same password. In the case of verification, the user identifier can be appended or concatenated. In the case of identification, however, this is not possible.

As alluded to herein, there may be some example embodiments wherein the fingerprint data may be in the form of the minutia template, or a template of minutia extracted from the fingerprint minutia template.

In a preferred example embodiment, the steps described in blocks 62 and 64 can comprise selecting n-tuples of minutia of a fixed size from the minutia template. The fixed size may be 2 thus the selected n-tuples will be selected pairs of minutia. In this regard, for each selected pair of minutia points, the method 50 comprises determining a class of the pair from a plurality of classes which partition the minutia template based on attributes of the minutiae of the pair, or the pair of minutiae, which are rotationally and translationally invariant. The fingerprint data is thus representative of the determined class of the selected pair of minutia. The fingerprint data for each minutia pair is hashed with the received probed user password, and the salt to generate a unit-digest hash, wherein the unit digests are combined to generate the hashed template as described herein. In some example embodiments, the hashed template generated in this fashion is used as a basis for other hashed templates which are used in a substantially similar manner.

The method steps 62, and 64 may at least be better explained with reference to FIG. 3 of the drawings which expands on the method steps 62, 64, and operation of the hasher 19.

The method 50 comprises using the generated hashed template to do one or more of enrolling the user to the system 10, determining an identify of the user, verifying the identity of the user, or authenticating the identity of the user based on their fingerprint or generated hashed template. To this end, the method 50 comprises transmitting, at block 66, the hashed template as well as the user identifier from the mobile computing device 12 of the user for the purposes of enrolment, identification, verification, or authentication of the user. The hashed template is transmitted to the server 30.

It is optional to also send the user identifier to the server 30, the only reason being the speed of identification versus verification. In the verification model, the server 30 or the hash matcher 35 looks up the enrolled hashed template and compares it against the probe. In the identification model, the probe is matched against all the enrolled hashes, and if a match is found, the associated user is identified.

In some example embodiments of the disclosure, the method 50 can begin at block 62 in response to receipt of a fingerprint minutia template extracted, for example, from a conventional scan scale image captured by a suitable conventional fingerprint scanner.

In other example embodiments, the method 50 can begin at block 60 in response to receipt of a scan scale image captured by suitable scanner. For example, a conventional mobile fingerprint scanner coupled to the mobile computing device 12 or from a database of stored scan scale images associated with users, for example, a government database.

In yet further example embodiments, the step of block 52 of receiving the user identifier and correspondingly transmitting the same in block 66 may be omitted in cases wherein no user identifier is required and/or the user identifier is hashed along with the user password, salt, and fingerprint data.

As alluded to above, the method 50 is discussed with reference to the same being carried out by the app 18 operating on the mobile computing device 12. However, it will be understood that in some example embodiments, the app 18, or components thereof, such as the hasher 19, may be software application/s stored or provided in the memory device 34 of the server 30. In some example embodiments, the app 18 merely prompts users for information which it receives and transmits to the server 30 for further processing in the manner described with reference to FIG. 2. For example, the app 18 may prompt the user for their user identifier in the form of their username, password, a scan of their finger, minutia template of their finger, or an image of their finger which they merely transmit to the at least one processor 32 of the server 30 for processing the manner discussed with reference to FIG. 2. These example embodiments may be less secure as sensitive data such as user passwords and fingerprint data or images are being transmitted and may be vulnerable for interception but are within the scope of the disclosure for completeness.

Turning to FIG. 3 of the drawings, wherein a flow diagram of a method in accordance with an example embodiment of the disclosure is generally indicated by reference numeral 51.

The method 51 expands on the method steps 62 and 64 as described above with reference to FIG. 2 and as such may be regarded as a method of hashing a fingerprint minutia template.

In this regard, the method 51 comprises processing, at block 61 by way of the hasher 19, a received or extracted fingerprint minutia template to extract or determine a set comprising a plurality of positionally distinct n-tuples of minutiae of fixed size from the received fingerprint minutia template. In a preferred example embodiment, the n-tuple is a minutia pair comprising a first minutia and a second minutia.

For each minutia pair in the selected set, the method 51 can comprise determining, at block 63, a unique class identifier or index (UCI) of the minutia pair. The UCI is associated with all of a predetermined number of equivalence classes of different type, based on attributes of the minutia pair, or minutiae of the minutia pair, which are rotationally and translationally invariant. In this regard, it will be noted that the UCI for each minutia pair in the template may be rotationally and translationally invariant. As described above, this may comprise allocating a minutia pair to a particular equivalence class, wherein membership is based on the attributes of the minutia pair, particularly the attributes of the distance between the minutiae of the minutia pair, the first and second relatively angle orientations, and a type of the first and second minutiae of the minutia pair.

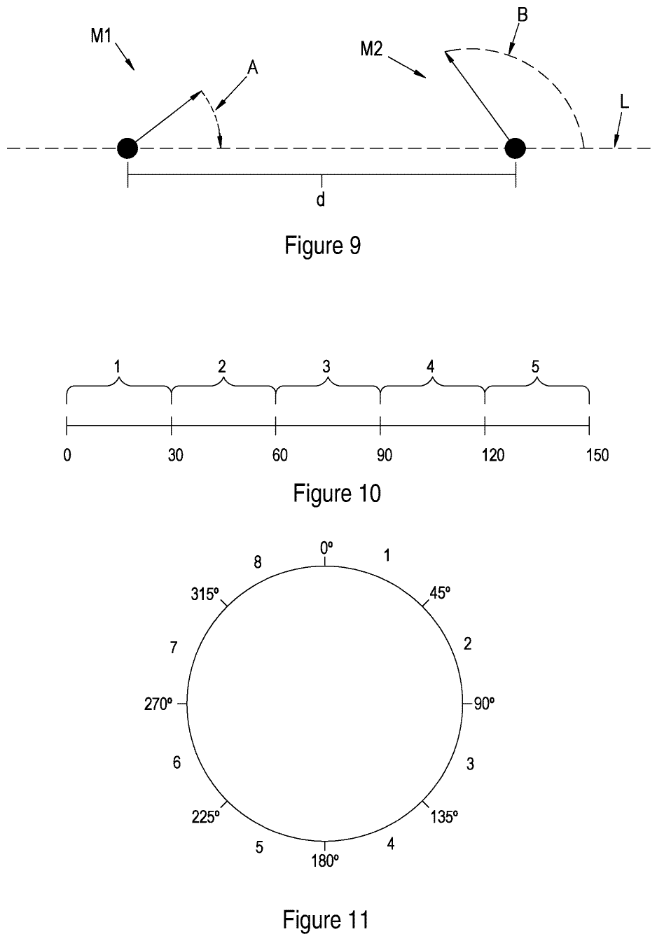

Referring also to FIGS. 9 to 11 of the drawings, FIG. 9 shows two illustrative minutia points m1 and m2 and the translation and rotation data obtained/derived therefrom. The rotation and translation data comprise features, particularly data indicative thereof and/or associated therewith, which are rotationally and translationally invariant as determined in a manner disclosed herein having regard only for the relationship between the points m1 and m2, themselves without any reference to external points which may be introduced as described in prior disclosures. As described herein and understood by those skilled in the art, minutia m1/2 may be represented by its position (x,y), orientation (angle) and type (bifurcation or ridge end).

The points m1 and m2 are separated by a distance d, wherein the distance d is a relative distance between the minutia points m1 and m2. Moreover, the points m1 and m2 have a first relative orientation angle A and second relative orientation angle B associated therewith, respectively. The relative orientation angle A is the orientation angle of minutia point m1 relative to a line L extending through and/or between the minutia points m1 and m2 as illustrated in FIG. 9. Similarly, the relative orientation angle A is the orientation angle of minutia point m2 relative to a line L extending through and/or between the minutia points m1 and m2 as illustrated in FIG. 9.

The features of distance d, relative orientation angles A, B as well as the type are rotationally and translationally invariant or independent features as they will not change as a user's natural variation rotationally and translationally in presenting their fingerprint for scanning at a scanner. In this regard, in the methodology disclosed herein, the method of determining the feature of distance may include determining the distance between the points m1 and m2. Determining the feature of the first relative orientation angle A can comprise determining an angle between the orientation angle of the minutia point m1 and a line or axis L connecting the two minutia points m1 and m2. Similarly, determining the feature of the second relative orientation angle B may comprise determining an angle between the orientation angle of the minutia point m2 and the line L.

As can be seen in FIG. 9, the features of distance and relative angles contemplated herein which are rotationally invariant are determined from just the points m1, m2 themselves and how they relate to each other as opposed to how they relate to any external points of reference. In this regard, it may be appreciated that the features of the minutia pair m1, m2 which are rotationally and translationally invariant may be features which are inherently associated with just the two minutia points m1, m2

Turning to FIG. 10, where a distance partition of interval [0,150) is illustrated wherein the distance is partitioned into distance equivalence classes. For example, distance is partitioned into five distance equivalence classes, viz. Class 1~[0, 30); Class 2~[30, 60); Class 3~[60, 90); Class 4~[90, 120); and Class 5~[120, 150).

Turning to FIG. 11, where an angle partition of interval [0,3600) is illustrated wherein the angles are partitioned angle equivalence classes. For, viz. Class 1~[0, 45°); Class 2~[45°, 90°); Class 3~[90°, 135°); Class 4~[135°, 180°); Class 5~[180°, 225°); Class 6~[225°, 270°); Class 7~[270°, 315°); and Class~[315°, 360°).

It follows that the method 51 can conveniently comprise partitioning the set into a plurality of partitions as described herein. In particular, a distance partition, and angle partition which are labelled or indexed partitions which are labelled or indexed by suitable identifiers in the manner described herein.

In particular, the method 51 comprises determining a distance between minutiae of the minutia pair, determining a unique distance identifier or index (UDI) of the at least one minutia pair, wherein the UDI is an identifier of the sub-interval of the distance partition containing the determined distance. The method 51 further comprises determining a first relative orientation angle of the first minutia of the minutiae pair; determining a second relative orientation angle of the second minutia of the minutiae pair; and determining a first unique angle identifier or index (UAI) of the minutia pair, wherein the first UAI is an identifier of the sub-interval of the angle partition, determined by the determined UDI and the map, containing the determined first relative orientation angle of the first minutia of the at least one minutiae pair, and determining a second UAI in a similar fashion for the second minutia. The method 51 also comprises determining a first type of identifying data associated with first minutia of the minutia pair, from at least two different identifying data types; and determining a second type of identifying data associated with the second minutia of the minutia pair, from the at least two different identifying data types.

The method 51 can comprise determining the UCI i for the minutia pair is based on the determined UDI, the first and second UAI, the first type of identifying data, and the second type of identifying data by way of the following equation:

$$i ≐ 4 {N}^{2} {i}_{d} + 4 {Ni}_{{ro}_{1}} - 4 {i}_{{ro}_{2}} + 2 {i}_{{t}_{1}} + {i}_{{t}_{2}} ,$$

wherein index iᵣₒ₁ is the index of the sub-interval containing the first relative orientation ro₁(m̅), in an indexed angle partition O[i_{d}], where each O[i_{d}] is a partition of angles into contiguous subintervals, calling O the relative orientation partitions; iᵣₒ₂ is the index of the subinterval containing the second relative orientation ro₂(m̅) in the angle partition O[i_{d}]; iₜ₁ is the first type index which his defined to 0 if the first minutiae of the pair is a bifurcation, and 1 otherwise; and iₜ₂ is the second type index which is defined to 0 if the second minutiae of the pair is a bifurcation, and 1 otherwise. N is typically the maximum number of sub-intervals of any O[i_{d}].

In any event, the method 51 can comprise combining by concatenating, at block 65, the determined UCI, the user password, and a salt into a combined dataset. As mentioned alluded to above, the method 51 may also comprise concatenating the user identifier as well prior to hashing.

The method 51 then comprises hashing, at block 67, the combined dataset with a hash function to obtain a unit-digest.

Lastly, the method 51 comprises collecting, at block 69, the unit-digests into a hashed template which may be used for one or more of enrolment, or matching for purposes of one or more of identification, authentication, and verification of the user.

In some example, embodiments, the method 51 can comprise using the generated hashed template, or the unit-digests, to derive further hashed templates as described herein, such as the compact, sharp, labelled, or absolute hashed template as described herein which may be used for one or more of enrolment, or matching for purposes of one or more of identification, authentication, and verification of the user. It will be appreciated that the derived hashed templates may increase the EER of matching.

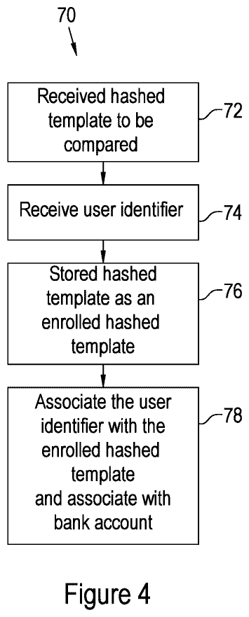

Reference is now made to FIG. 4 of the drawings wherein a flow diagram of a method of enrolling a user, particularly their hashed fingerprint template in the database 38 is generally indicated by reference numeral 70. The method 70 is typically performed by the server 30 in communication with the mobile computing device 12.

A user to be registered or enrolled to use the system 10, for example, to access their bank accounts in the database 46, proceeds with commencing enrolling themselves by way of their mobile computing device 12. In particular, the method 50 is followed and the generated hashed template is transmitted wirelessly over the network 24 to the server 30.

The method 70 comprises receiving, at block 72 at the server 30, the generated hashed template to be enrolled from the mobile computing device 12 of the user, and receiving, at block 74, the user identifier. As mentioned, the user identifier may be optional in some example embodiment implementations.

The method 70 comprises storing, at block 76, the received hashed template as an enrolled template in the database 38 and, associating, at block 78, the enrolled template with the user identifier. In some example embodiments, the user identifier may map the enrolled template with the associated bank account of the user stored in the database 46.

The hashed templates may only be as strong as their determining password and thus the app 18 must prompt the user for a strong password and/or present one to the user. With knowledge of the parameters, the salts and the password, it is feasible to recover the determining minutia template. This may be true for all biometric key-binding systems, and hence why secure password-less biometric hashing is impossible.

If an attacker has access to a matching score of standard fingerprint matching systems, then this can be exploited to reveal the enrolled fingerprints, through techniques such as hill-climbing. Even if the matching score is hidden, and only a yes/no interface is available, this too may be exploited, due to the low EER of fingerprint matching systems, which are currently at levels between 0.05 to 0.001. The attacker begins by iterating through a few hundred (to a few thousand) random fingerprints (from available fingerprint databases) and, due to the low EER, will soon find a match. While this matching fingerprint is not the real fingerprint, it will certainly pass as such. Further, the attacker can remove minutiae and retest, until they find a minimal sets that matches. By dropping a single minutia from a minimal set, the attacker can then find more real minutiae, by iterating over a single minutia and adding it to the set until a match occurs again. The attacker can eventually recover the real fingerprint.

In a scenario in which an attacker knows the salt, and has a pure hashed template (no password), or a key-bound hashed template with knowledge of the key. The hash matcher presents as that of a standard (non-hashed) fingerprint matcher, providing either an increasing matching score in all currently existing hash matchers, or possible just a yes/no interface (although no existing hash-matchers exist). Either way, as “standard” fingerprint matchers, they must be vulnerable to the two attacks described above.

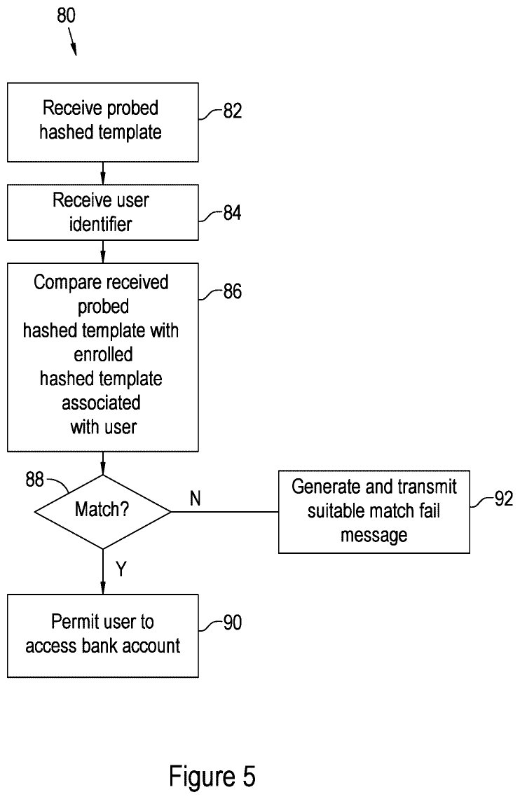

Reference is now made to FIG. 5 of the drawings wherein a flow diagram of a method of matching a fingerprint hash or hashed fingerprint template is generally indicated by reference numeral 80. The method 80 is typically performed by the server 30 in communication with the mobile computing device 12.

As alluded to above, a user wanting to be, or requiring to be, identified, verified, or authenticated, for example, to access their bank account stored in the database 46 must first generate a hash template by way of their mobile computing device 12 as discussed herein, for example, but not limited to, with reference to FIG. 2. In particular, the method 50 is followed and the generated hashed template to be probed is transmitted wirelessly from the mobile computing device 12 to the server 30, over the network 24. It will be appreciated that the hashed template may be any of the hashed templates generated and described in detail herein.

The method 80 comprises receiving, at block 82 at the server 30, the generated probed hashed template to be compared with one or more enrolled hashed templates stored in the database 38; and the receiving, at block 84, the user identifier.

The method comprises retrieving the enrolled hashed template associated with, or corresponding to, the user identifier stored in the database 38; and comparing, at block 86, the enrolled hashed template with probed hashed templated to determine a match by way of the hash matcher 35.

The matching or comparison at block 86 is described in detail and mathematically above as will be well understood by those skilled in the art. For example, in one example embodiment, when a probe and enrolled class match, their remainders can be compared (by subtraction) to provide additional accuracy. In this way the system described herein achieves much higher accuracy than prior art systems, by having larger/fewer equivalence classes and then using the encrypted remainders. The use of remainders as described herein addresses added inaccuracy problems associated with approximating metric values with equivalence classes, as identified by prior disclosures. In particular, if the classes are too big, false positives occur. Conversely, if the classes are too small, false positives occur, in particular when values lie near to the edges of the class. The present disclosure describes a method for encrypting the remainders using the key of the equivalence class, such that the probed and enrolled remainders can still be compared by subtraction. This is done by hashing the key with another salt and the user password, treating this hash as a number, and shifting the remainders by this number as described above and mathematically herein.

Moreover, fingerprint matching algorithms typically have two phases. First key features of the probed and enrolled are matched. Secondly the pairs of matched features are then analysed against the other pairs of matched features. The present disclosure provides for the second stage matched pair comparison. In summary, in one embodiment of the disclosure the minutiae of the template are randomly numbered, and the minutiae numbers that contributed to the feature are recorded, along with the hash and encrypted remainders. This enables the present system/methodology disclosed to find cycles between the matched features, as is done in standard biometric matching algorithms. Cycle matching improves the accuracy of matching by an order of magnitude.

Another embodiment additionally records an absolute angle and absolute distance with each hashed feature. The rotation and translation between two pairs of matched hashes/features can then be calculated by subtraction. The algorithm can then count the matched pairs with similar rotation and translation. These absolute values recorded are encrypted with each hash/feature, by shifting them by a number determined by hashing the key with another salt and the user's password.

If a match is determined, at block 88, the method 80 comprises permitting the user access to their bank account. However, if a match is not determined, at block 88, the method 80 comprises generating and/or transmitting a suitable failure message to the user via the app 18 which may prompt the user to re-generate and re-transmit a hashed template for probing.

Those skilled in the art will appreciate that determining a match can comprise determining whether there is correlation between the received hashed templated and that of the enrolled hashed template which falls within a predetermined tolerance range.

It will be understood by those skilled in the art that determining a match can comprise determining, by way of the hash matcher 35, whether there is correlation between the received hashed templated and that of the enrolled hashed template which falls within a predetermined tolerance range.

In particular, the input to the hash matcher 35 is two hashes, a probed and an enrolled hashed template, and the output is a non-negative matching score, where 0 means no match, while the higher the score the better the match. If the two hashes were generated with different passwords or salts, then the matching score will be 0 with cryptographically high probability, otherwise, the matching score behaves like a Bozorth3 based match of the determining minutiae templates.

It will be understood that the more minutiae that contribute to a hash/feature the more hashes/features there are in the actual hashed template. In the present disclosure, the approach of using remainders and cross matching, an accuracy of close to standard biometric matching is achieved, with only the need for features built from two minutia. For a typical minutiae template with 50 minutiae the present disclosure requires only 50*49=2450 hashes in each hashed template. Thus, the templates disclosed herein are small to transport and store, and very fast to match. It will be understood that further that the more minutiae that contribute to a hash/feature, the greater the number of equivalence classes that need to be combined into one equivalence class, and hence (exponentially) the greater the inaccuracy.

Moreover, the present disclosure show a method for ordering the features determined by a salt and the users password, and which does not decrease the entropy of the hash.

Though not illustrated, it will be appreciated that in some example embodiments, the user may access the website 42 to gain access to their accounts stored in the database 46 and the system 10 may prompt the user, via the app 18 on their mobile computing device 12, for input of at least of the password and capturing of an image of the user's finger/fingerprint so that the app 18 can generate and send the hashed template to the server 30 for authorisation prior to enabling the user to access their bank accounts. This procedure may be substantially like two-step authentication systems which sends a separate code to a mobile computing device associated with the user for input via a website 42 to authorise access to the user's bank account via the website 42. The difference being that instead or sending a code and waiting for the input of said code on the website 42, the system 10 prompts the user for the password and fingerprint photograph via the mobile computing device 12, which is processed in a manner described herein to generate the hashed template which is and transmitted to the server 30 for matching thereby to give access to user to their accounts stored in the database 46 via the website 42 on a successful match. It will be appreciated by those skilled in the art that the above scenario illustrates that the permutations of the disclosure herein may be numerous and thus should not detract from the disclosure disclosed herein.

Referring to FIG. 6 of the drawings where a flow diagram of a method in accordance with an example embodiment of the disclosure is generally indicated by reference numeral 100.

As mentioned above, method 100 may typically be a contactless acquisition methodology to obtain a scan scale image from which a conventional fingerprint minutia template may extracted in a conventional manner.

The method 100 comprises receiving, at block 102 via the app 18, a photograph or image containing at least one finger, having a fingerprint, therein, captured by the camera 20 of the mobile computing device 12.

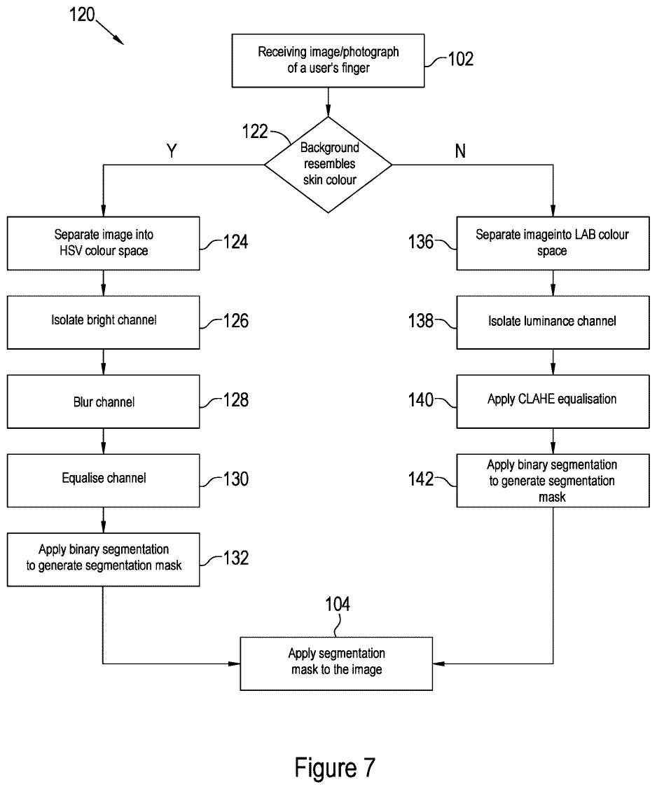

The method 100 comprises applying, at block 104, a segmentation mask to the image to obtain a background-removed image based on whether or not a background of the received image resembles skin colour, wherein the background-removed image contains the at least one finger isolated from its background. The method step 104 of block 104 is expanded upon in FIG. 7 of the drawings.

The method 100 comprises applying, at block 106, a Butterworth filter to the background-removed image; applying, at block 108, a Gaussian filter to the Butterworth filtered image; and applying, at block 110, a Tophat filter to obtain an illumination-enhanced image. The steps 106 to 110 may typically be the processing steps to process the background-removed image to obtain an illumination-enhanced image.

The method 100 can further comprise processing the illumination-enhanced image to obtain a contrast-enhanced image, which has enhanced contrast relative to the illumination-enhanced image, by applying, at block 112, a median filter to the illumination-enhanced image; and sharpening, at block 114, the median filtered image to obtain the contrast-enhanced image.

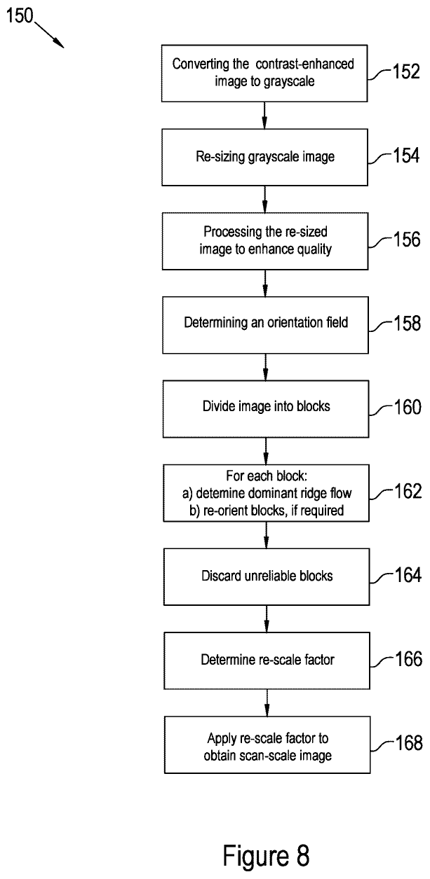

The method 100 then further comprises re-scaling, at block 116, the contrast-enhanced image to generate a scan scale image which approximates a fingerprint scanned with a conventional fingerprint scanner, and/or a fingerprint obtained via conventional ink-based fingerprinting techniques. The method step 116 is explained in greater detail with reference to FIG. 8 of the drawings.

In a preferred example embodiment, not illustrated, the method 100 includes computing an image quality score of the images processed, and removing or discarding images of a low quality, i.e., having an unacceptable image quality score. In this regard, the method can comprise determining an image quality score of the contrast-enhanced image; comparing the image quality score for the image with a predetermined image quality score threshold, and discarding an image having a quality score below the predetermined quality score threshold. The threshold may be determined experimentally.

In one example embodiment, the method 100 comprises processing the contrast-enhanced image to:
i. compute a reliability score associated with the contrast-enhanced image;
ii. compute an Orientation Certainty Level (OCL) score,
iii. compute NIST Fingerprint Image Quality (NFIQ) score, and
iv. combine the scores mentioned in i. to iii. to determine an image quality score.

The method 100 may thus comprise comparing the determined image quality score of a contrast-enhanced image with an experimentally determined quality score threshold; and removing or discarding the images falling outside/below the quality score threshold.

Turning to FIG. 7 of the drawings, the method step contained in block 104 is expanded upon by a flow diagram illustrating a method 120 for determining the segmentation mask to be applied in step 104.

In particular, after receiving the image of the finger, at block 102, the received image is processed to determine, at block 122, if the background in the image resembles skin colour. To this end, it will be noted that the received photographic image typically has a finger in the foreground, wherein the app 18 may direct the user to ensure that the user's finger is within the field of view, particularly in the foreground of the field of view of the camera 20 before capturing the image.

If the background of the received image is determined to resemble skin colour, the method 120 comprises:
separating the received image to a HSV colour space, at block 124;
isolating the bright channel, at block 126;
blurring the channel, at block 128;
equalizing the channel, at block 130; and
applying binary segmentation, at block 132, to generate or obtain the segmentation mask.

On the other hand, if, at block 122, it is determined that the background of the received image does not resemble skin colour, the method 120 comprises:
separating the received image to a LAB colour space, at block 136;
isolating the luminance channel, at block 138;
applying a CLAHE equalization to luminance channel, at block 140; and
applying binary segmentation, at block 142, to generate or obtain the segmentation mask.

Whatever route taken to obtain the segmentation mask, the method 120 comprises applying the determined or generated segmentation mask to the received image, at block 104.

Reference is now made to FIG. 8 of the drawings wherein another flow diagram of a method is generally indicated by reference numeral 150. The method 150 typically serves to expand on the step 116 of the method 100 of FIG. 2 which essentially serves to re-scale the processed image to obtain the scan scale image with 500 dpi.

In this regard, the method 150 comprises converting, at block 152, the contrast-enhanced image to grayscale image. Though not illustrated, the method 150 may comprise cropping the grayscale image, if required.

The method 150 can comprise re-sizing, at block 154, the cropped image to predetermined dimensions of a particular width W and height H to obtain an image with dimensions W×H.

The method 150 can comprise processing, at block 156, the re-sized image to enhance the quality thereof. This may be done by performing local contrast enhancement and applying gaussian filter to obtain a processed image.

The method 150 can comprise determining or computing, at block 158, an orientation field, of the image, wherein the orientation field is indicative/representative of and/or associated with a directionality of ridges in the processed image.

The method 150 comprises dividing, at block 160, the processed image into a predetermined number of segments, for example, N×M sized blocks.

The method 150 comprises, for each block, at block 162:
using a corresponding block for the orientation field, determine the dominant ridge flow, and
reorient block so that the ridges are at 90 degrees.

The method 150 comprises discarding, at block 164, unreliable blocks.

The method 150 further comprises calculating, at block 166, a re-scale factor to be applied to the image once the unreliable blocks have been discarded. To this end, though not illustrated, the method 150 comprises determining an averaging the ridge count in the image, and computing the rescale factor as a ratio of the determined average ridge count and an experimentally determined desired ridge count. Differently stated, the rescaleFactor=AverageRidgeCount/DesiredRidgeCount.

The method 150 then comprises resizing, at block 168, the image using the determined rescale factor to get a correctly scan scaled fingerprint image.

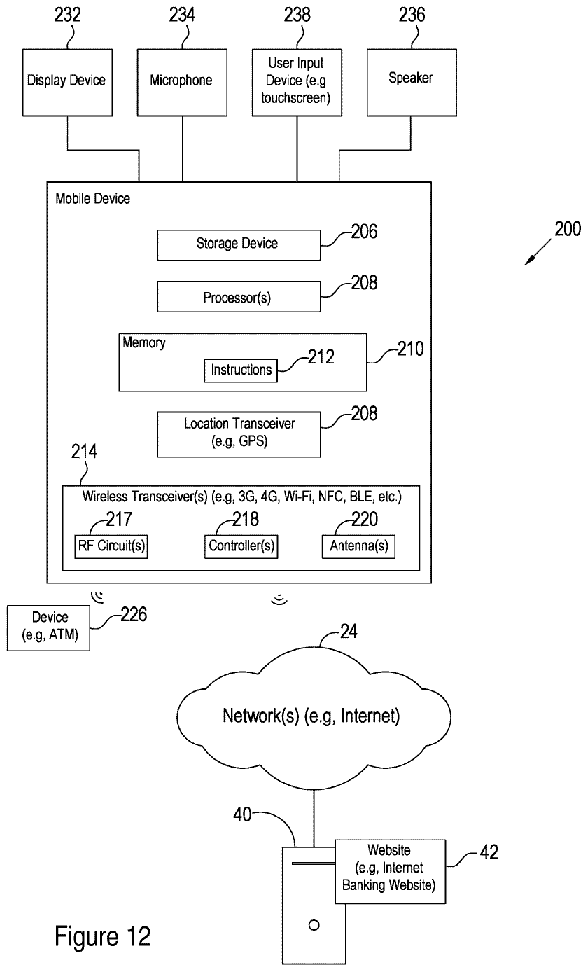

Referring to FIG. 12 of the drawings, an example of a mobile computing device 200 is shown. The mobile computing device 200 may be configured to perform one or more of the functions and methods described above with reference to FIGS. 1 to 11 of the drawings. In one example embodiment, the mobile device 100 may include or correspond to the mobile device 12 of FIG. 1 as described herein.

The device 200 includes a computer-readable storage device 206, one or more processors 208 (e.g., a central processing unit (CPU), a digital signal processor (DSP), a graphics processing unit (GPU), etc.) and a memory device or memory 210. The storage device 206 may be implemented as read-only memory (ROM), random access memory (RAM), and/or persistent storage, such as a hard disk drive, a flash memory device, or other type of storage device. The memory 210 is non-transitory computer readable medium configured to store instructions 212 which are executable by the processor 208 to perform one or more of the functions or methods described above with reference to FIGS. 1 to 11. In this regard, the memory 210 may be configured to store the software application 18 of FIG. 1. The computer-readable storage device 206 is not transitory or a signal.

The mobile device 200 also includes a location device 216 (e.g., a GPS transceiver) and one or more wireless transceivers 214 that enable the mobile device 202 to exchange signals with (e.g., receive signals from and/or send signals to) other devices. Each wireless transceiver 214 may include or be coupled to radio frequency (RF) circuitry 217, a controller 218, and/or an antenna 219. In illustrative examples, the wireless transceivers 214 include a third generation (3G) transceiver, a fourth generation (4G) transceiver, a Wi-Fi® transceiver, a near field communication (NFC) transceiver, a BLUETOOTH® or BLUETOOTH® low energy (BLE) transceiver, or any combination thereof.

The mobile device 200 is configured to utilize one or more of the wireless transceivers 214 for direct peer-to-peer communication and communication via one or more networks 24, such as the internet. To illustrate, the mobile device 200 may communicate with an external device 226 (e.g., an automated teller machine (ATM) for contact-less ATM authentication) via a peer-to-peer wireless channel (e.g., BLUETOOTH, BLE, or NFC) and may communicate with the web server 40 hosting the website 42 via a cellular or Wi-Fi wireless channel as described herein.

In the example of FIG. 12, the mobile device 200 includes or is coupled to input devices and output devices. For example, the mobile device 200 may include or may be coupled to a display device 232, a microphone 234, a speaker 236, and/or a user input device 238 (e.g., a touchscreen). It should be noted that, while illustrated as outside of the mobile device 200, one or more of the devices 232-238 may be integrated into a housing of the mobile device 200, such as in the case of a mobile phone, a tablet computer, or a bespoke electronic device.

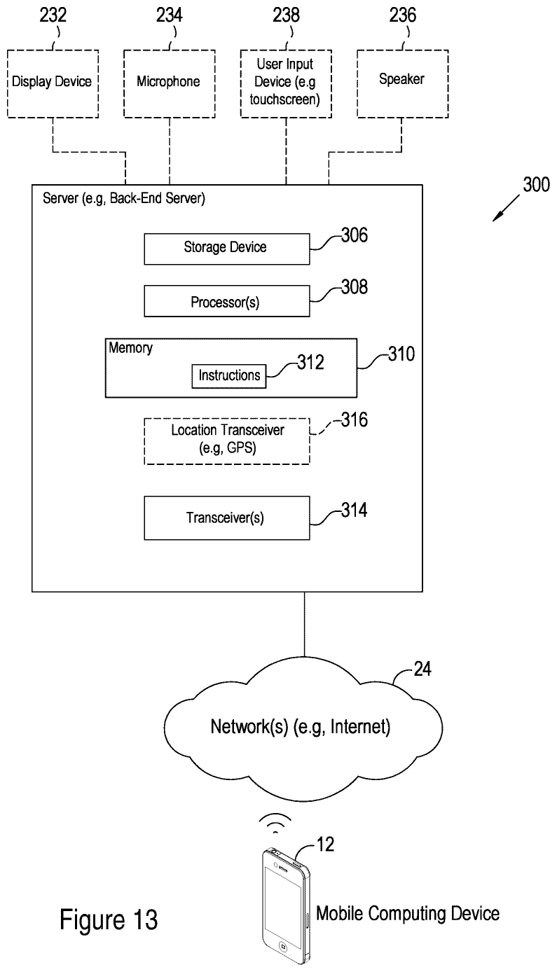

Referring to FIG. 13 of the drawings, an illustrative example of a server 300 is shown. The server 300 may be configured to perform one or more of the functions and methods described above with reference to FIGS. 1 to 11. In a particular implementation, the server 300 includes or corresponds to the back-end server 30 of FIG. 1.

The server 300 includes a computer-readable storage device 306, one or more processors 308 (e.g., a central processing unit (CPU), a digital signal processor (DSP), a graphics processing unit (GPU), etc.) and a memory 310. The storage device 306 may be implemented as read-only memory (ROM), random access memory (RAM), and/or persistent storage, such as a hard disk drive, a flash memory device, or other type of storage device. The memory 310 is configured to store instructions 312 executable by the processor 308 to perform one or more of the functions or methods described above with reference to FIGS. 1 to 11. The computer-readable storage device 306 is not a signal.

The server 300 also includes one or more transceivers 314 that enable the server 300 to exchange signals with (e.g., receive signals from and/or send signals to) other devices. In some implementations, the transceivers 314 are wireless transceivers, and each transceiver 314 may include or be coupled to radio frequency (RF) circuitry, a controller, and/or an antenna. In illustrative examples, the transceivers 314 include a third generation (3G) transceiver, a fourth generation (4G) transceiver, a Wi-Fi® transceiver, a near field communication (NFC) transceiver, a BLUETOOTH® or BLUETOOTH® low energy (BLE) transceiver, a wired transceiver, or any combination thereof. In the example of FIG. 10, the server 300 is configured to utilize one or more of the transceivers 314 for communication via one or more networks 24, such as the internet. To illustrate, the server 300 may communicate with mobile device 12 or 200 via the internet.

The server 300 optionally includes a location device 316 (e.g., a GPS transceiver). In the example of FIG. 13, the server 300 also optionally includes or is coupled to input devices and output devices. For example, the server 300 may optionally include or may be coupled to a display device 332, a microphone 334, a speaker 336, a user input device 338 (e.g., a touchscreen), or a combination thereof.

The systems and methods disclosed herein provides a convenient way to enhance security of biometric systems, for example, banking systems in a manner which does not transmit or store user passwords or user fingerprints.

1. A fingerprint hash matching method, the method comprises:
storing a plurality of enrolled hashed templates in a memory device communicatively coupled to at least one processor, wherein each enrolled hashed template comprises a hash, with a suitable hashing function, of an enrolled user password, a salt, and fingerprint data associated with a fingerprint of an enrolled user obtained from a fingerprint minutia template containing a plurality of minutiae associated with the fingerprint of the enrolled user, wherein the fingerprint data comprises a unique class identifier (UCI) associated with each n-tuple of a plurality of n-tuples of minutiae from the minutia template, an n-tuple is of a fixed size and comprises at least a pair of minutia points, wherein the UCI is determined from at least equivalence classes which partition the minutia template based on features of the at least one minutiae pair which are inherently rotationally and translationally invariant, wherein each enrolled hashed template further comprises suitable remainder hashes associated with the features of each n-tuple which are rotationally and translationally invariant, wherein the remainder hashes are associated with remainders from associating the features determined to be rotationally and translationally invariant with the respective equivalence classes; and
comparing a probed hashed template with one or more enrolled hashed templates stored in the memory device to determine a match.

2. A fingerprint hash matching method as claimed in claim 1, further comparing hashes of the probed hashed template with hashes of enrolled hashed templates; and comparing remainder hashes of the probed hashed template with remainder hashes of enrolled hashed templates to determine a match.

3. A fingerprint hash matching method as claimed in claim 1, wherein the remainder hashes comprise mathematically shifted remainders.

4. A fingerprint hash matching method as claimed in claim 3, wherein the mathematically shifted remainders are shifted by real values associated with hashes of unique identifiers of at least one equivalence class, user password, and suitable remainder salts.

5. A fingerprint hash matching method as claimed in claim 1, further comprising:
processing a probed fingerprint minutia template containing a plurality of minutiae associated with the fingerprint of the probed user to obtain fingerprint data associated with, or representative of, features of the fingerprint of the probed user which are rotationally and translationally invariant, wherein the method comprises determining a plurality of positionally distinct n-tuples of minutiae of fixed size n from the probed fingerprint minutia template, and wherein each n-tuple comprises at least one minutia pair, for each n-tuple in the determined plurality of positionally distinct n-tuples, the method comprises:
determining features of the n-tuple which are inherently rotationally and translationally invariant based on one or more relationships between the minutia of the at least one minutia pair;
associating the determined features with a predetermined number of corresponding equivalence classes;
recording remainders associated with the associating the determined features with the corresponding equivalence classes;
determining a unique class identifier (UCI) of the n-tuple based on at least the associated equivalence classes;
mathematically shifting the remainders by a value determined by the UCI, the user password, and a salt to generate remainder hashes;
combining the determined UCI, the user password, and a salt into a combined dataset;
hashing the combined dataset with a suitable hashing function to obtain a unit-digest; and
combining the unit-digests and remainder hashes associated with the n-tuples into the probed hashed template.

6. A fingerprint hash matching method as claimed in claim 1, further comprising:
receiving a probed user password;
receiving an image captured by a camera of an endpoint computing device, wherein the image contains at least one fingerprint of the probed user; and
processing the received image to extract a probed fingerprint minutia template containing a plurality of minutiae associated with the at least one fingerprint of the probed user contained in the image.

7. A fingerprint hash matching method as claimed in claim 6, further comprising
processing the received image by:
generating a scan scale image of the fingerprint based on the received image; and
extracting the fingerprint minutia template from the scan scale image.

8. A fingerprint hash matching method as claimed in claim 1, wherein each enrolled hashed template stored in the memory device is uniquely associated with an enrolled user by way of one or more unique user identifier/s, wherein method comprises:
receiving a user identifier associated with the probed user;
retrieving the enrolled hashed template associated with the received user identifier stored in the memory store; and
comparing the retrieved enrolled hashed template with the probed hashed template to authenticate the probed user.

9. A fingerprint hash matching system, wherein the system comprises:
a memory device storing a plurality of enrolled hashed templates, wherein each enrolled hashed template comprises a hash, with a suitable hashing function, of an enrolled user password, a salt, and fingerprint data associated with a fingerprint of an enrolled user obtained from a fingerprint minutia template containing a plurality of minutiae associated with the fingerprint of the enrolled user, wherein the fingerprint data comprises a unique class identifier (UCI) associated with each n-tuple of a plurality of n-tuples of minutiae from the minutia template, wherein an n-tuple is of a fixed size and comprises at least a pair of minutia points, wherein the UCI is determined from at least equivalence classes which partition the minutia template based on features of the at least one minutiae pair which are inherently rotationally and translationally invariant, wherein each enrolled hashed template further comprises suitable remainder hashes associated with the features of each n-tuple which are rotationally and translationally invariant, and wherein the remainder hashes are associated with remainders from associating the features determined to be rotationally and translationally invariant with the respective equivalence classes; and
at least one processor communicatively coupled to the memory device and configured to compare a probed hashed template with one or more enrolled hashed templates stored in the memory device to determine a match.

10. A fingerprint hash matching system as claimed in claim 9, wherein the at least one processor is configured to compare hashes of the probed hashed template with hashes of enrolled hashed templates; and compare remainder hashes of the probed hashed template with remainder hashes of enrolled hashed templates to determine a match.

11. A fingerprint hash matching system as claimed in claim 9, wherein the remainder hashes comprise mathematically shifted remainders.

12. A fingerprint hash matching system as claimed in claim 11, wherein the mathematically shifted remainders are shifted by real values associated with hashes of unique identifiers of at least one equivalence class, user password, and suitable remainder salts.

13. A fingerprint hash matching system as claimed in claim 9, wherein the system comprises an endpoint computing device associated with a probed user, wherein the endpoint computing device comprises a data store communicatively coupled to a suitable processor of the endpoint computing device, and wherein the processor of the endpoint computing device is configured to:
process a fingerprint minutia template containing a plurality of minutiae associated with the at least one fingerprint of the probed user to obtain fingerprint data, which is associated with, or representative of, attributes of the fingerprint which are rotationally and translationally invariant, wherein the processor is configured to determine a plurality of positionally distinct n-tuples of minutiae of fixed size n from the probed fingerprint minutia template, wherein each n-tuple comprises at least one minutia pair, for each n-tuple in the determined plurality of positionally distinct n-tuples, and wherein the processor of the endpoint device is configured to:
determine features of the n-tuple which are inherently rotationally and translationally invariant based on one or more relationships between the minutia of the at least one minutia pair;
associate the determined features with a predetermined number of corresponding equivalence classes;
record remainders associated with associating the determined features with the corresponding equivalence classes;
determine a unique class identifier (UCI) of the n-tuple based on at least the associated equivalence classes;
mathematically shift the remainders by a value determined by the UCI, the user password, and a salt to generate remainder hashes;
combine the determined UCI, the user password, and a salt into a combined dataset; and
hash the combined dataset with a suitable hashing function to obtain a unit-digest;
combine the unit-digests and remainder hashes associated with the n-tuples to generate the probed hashed template; and
transmit the probed hashed template to the at least one processor.

14. A fingerprint hash matching system as claimed in claim 13, wherein the processor of the endpoint computing device is configured to:
receive a probed user password;
receive an image captured by a camera of an endpoint computing device, wherein the image contains at least one finger or finger having a fingerprint of the probed user; and
process the received image to extract the fingerprint minutia template containing a plurality of minutiae associated with the at least one fingerprint of the probed user contained in the image.

15. A fingerprint hash matching system as claimed in claim 14, wherein the processor of the endpoint computing device is configured to process the received image by:
generating a scan scale image of the fingerprint based on the received image; and
extracting the fingerprint minutia template from the scan scale image.

16. A fingerprint hash matching system as claimed in claim 9, wherein the at least one processor is provided at a server, and wherein the at least one processor is configured to:
process a fingerprint minutia template containing a plurality of minutiae associated with the at least one fingerprint of the probed user to obtain fingerprint data associated with the fingerprint of the probed user, wherein the fingerprint data is rotationally and translationally invariant, wherein the at least one processor is configured to determine a plurality of positionally distinct n-tuples of minutiae of fixed size n from the probed fingerprint minutia template, wherein each n-tuple comprises at least one minutia pair, for each n-tuple in the determined plurality of positionally distinct n-tuples, and wherein the at least one processor is configured to:
determine features of the n-tuple which are inherently rotationally and translationally invariant based on one or more relationships between the minutia of the at least one minutia pair;
associate the determined features with a predetermined number of corresponding equivalence classes;
record remainders associated with associating the determined features with the corresponding equivalence classes;
determine a unique class identifier (UCI) of the n-tuple based on at least the associated equivalence classes;
mathematically shift the remainders by a value determined by the UCI, the user password, and a salt to generate remainder hashes;
combine the determined UCI, the user password, and a salt into a combined dataset;
hash the combined dataset with a suitable hashing function to obtain a unit-digest; and
combine the unit-digests and remainder hashes associated with the n-tuples to generate the probed hashed template.

17. A fingerprint hash matching system as claimed in claim 9, wherein the at least one processor is configured to:
receive a probed user password;
receive an image captured by a camera of an endpoint computing device, wherein the image contains at least one fingerprint of the probed user; and
process the received image to extract the fingerprint minutia template containing a plurality of minutiae associated with the at least one fingerprint of the probed user contained in the image.

18. A fingerprint hash matching system as claimed in claim 17, wherein the at least one processor is configured to process the received image by:
generating a scan scale image of the fingerprint based on the received image; and
extracting the fingerprint minutia template from the scan scale image.

19. A fingerprint hash matching system as claimed in claim 9, wherein each enrolled hashed template stored in the memory device is uniquely associated with an enrolled user by way of one or more unique user identifier/s, and wherein at least one processor is configured to:
receive a user identifier associated with the probed user;
retrieve the enrolled hashed template associated with the received user identifier stored in the memory device; and
compare the retrieved enrolled hashed template with the probed hashed template so as to authenticate the probed user.

20. A non-transitory computer executable medium storing computer executable instructions which when executed on one or more processors cause the one or more processors causes the one or more processors to perform the method of claim 1.
